(19) United States
(12) Patent Application Publication
(10) Pub. No.: US 2023/0291877 A1
(43) Pub. Date: Sep. 14, 2023

(54) INFORMATION PROCESSING DEVICE AND METHOD

(71) Applicant: Sony Group Corporation, Tokyo (JP)

(72) Inventor: Kiyoto SOMEYA, Tokyo (JP)

(73) Assignee: Sony Group Corporation, Tokyo (JP)

(21) Appl. No.: 18/016,612

(22) PCT Filed: Aug. 11, 2021
(86) PCT No.: PCT/JP2021/029626

§ 371 Date: Jan. 17, 2023

(30) Foreign Application Priority Data
Aug. 24, 2020 (JP) 2020-140609

(51) Int. Cl. H04N 9/31; G06T 7/73

(52) U.S. Cl. CPC H04N 9/3182; G06T 7/73; H04N 9/3185; G06T 2207/10024; G06T 2207/30244

(57) ABSTRACT

A present disclosure relates to an information processing device and method capable of more easily correcting a color shift.

A color shift is corrected on the basis of three-dimensional (3D) projection position of each of optical devices of a projection unit that projects red, green, and blue (RGB) light using the optical devices different from each other. For example, a color shift amount indicating magnitude and a direction of the color shift is derived, and correction is performed in such a manner that the derived color shift amount is reduced. The present disclosure can be applied to, for example, an information processing device, a projection device, an imaging device, a projection imaging device, a projection imaging control device, an image projection imaging system, and the like.

### TECHNICAL FIELD

The present disclosure relates to an information processing device and a method, and more particularly, to an information processing device and a method capable of more easily correcting color shift.

### BACKGROUND ART

Conventionally, there has been a projection device (what is called a multi-plate projector) that projects light using an optical device such as a liquid crystal panel for each wavelength region component (so to speak, for each color). For example, there has been a three-plate projector that projects RGB light using optical devices different from each other.

In such a multiple-plate projector, even if RGB panels are fixed with high accuracy at the time of manufacture, a slight shift occurs between the RGB panels due to impact and aging, and consequently, a shift occurs in RGB light beams of the same pixel projected on the screen, which may cause color shift.

Accordingly, an interpolation method has been considered in which an RGB shift is detected and color shift correction is performed by a 2D approach (2D signal processing) that captures appearance of a camera (linearity such as crosshatch projected on a flat screen) (see, for example, Patent Document 1).

### CITATION LIST

### Patent Document

Patent Document 1: Japanese Patent Application Laid-Open No. 2017-161664

### SUMMARY OF THE INVENTION

### Problems to be Solved by the Invention

However, this method can be applied only to a case of a flat screen because of the linearity of a measurement pattern such as crosshatch. Thus, it has been difficult to cope with projection onto a curved screen, displacement in a depth direction, and the like. Thus, complicated work such as manual adjustment has been required.

The present disclosure has been made in view of such circumstances, and makes it possible to more easily correct a color shift.

### Solutions to Problems

An information processing device according to one aspect of the present technology is an information processing device including a color shift correction unit that corrects a color shift on the basis of a three-dimensional (3D) projection position of each of optical devices of a projection unit that projects red, green, and blue (RGB) light using the optical devices different from each other.

An information processing method according to one aspect of the present technology is an information processing method including correcting a color shift on the basis of a three-dimensional (3D) projection position of each of optical devices of a projection unit that projects red, green, and blue (RGB) light using the optical devices different from each other.

In the information processing device and method according to one aspect of the present technology, the color shift is corrected on the basis of the 3D projection position of each of the optical devices of the projection unit that projects the RGB light using the optical devices different from each other.

### BRIEF DESCRIPTION OF DRAWINGS

FIG. 1 is a diagram describing a color shift.

FIG. 2 is a block diagram illustrating a main configuration example of a projection imaging system.

FIG. 3 is a block diagram illustrating a main configuration example of a portable terminal device.

FIG. 4 is a functional block diagram illustrating an example of main functions achieved by an information processing unit.

FIG. 5 is a block diagram illustrating a main configuration example of a projector.

FIG. 6 is a functional block diagram illustrating an example of main functions achieved by the information processing unit.

FIG. 7 is a flowchart illustrating an example of a flow of color shift correction processing.

FIG. 8 is a diagram illustrating an example of structured light.

FIG. 9 is a view illustrating an example of a state of projection and imaging.

FIG. 10 is a diagram illustrating an example of a state of corresponding point detection.

FIG. 11 is a diagram illustrating an example of a state of camera posture estimation.

FIG. 12 is a diagram illustrating an example of a state of the camera posture estimation.

FIG. 13 is a diagram illustrating an example of a state of the camera posture estimation.

FIG. 14 is a diagram illustrating an example of a state of 3D point restoration.

FIG. 15 is a functional block diagram illustrating an example of main functions achieved by the information processing unit.

FIG. 16 is a functional block diagram illustrating an example of main functions achieved by the information processing unit.

FIG. 17 is a flowchart illustrating an example of a flow of the color shift correction processing.

FIG. 18 is a block diagram illustrating a main configuration example of the projection imaging system.

FIG. 19 is a view illustrating an example of a state of projection and imaging.

FIG. 20 is a block diagram illustrating a main configuration example of a control device.

FIG. 21 is a functional block diagram illustrating an example of main functions achieved by the information processing unit.

FIG. 22 is a functional block diagram illustrating an example of main functions achieved by the information processing unit.

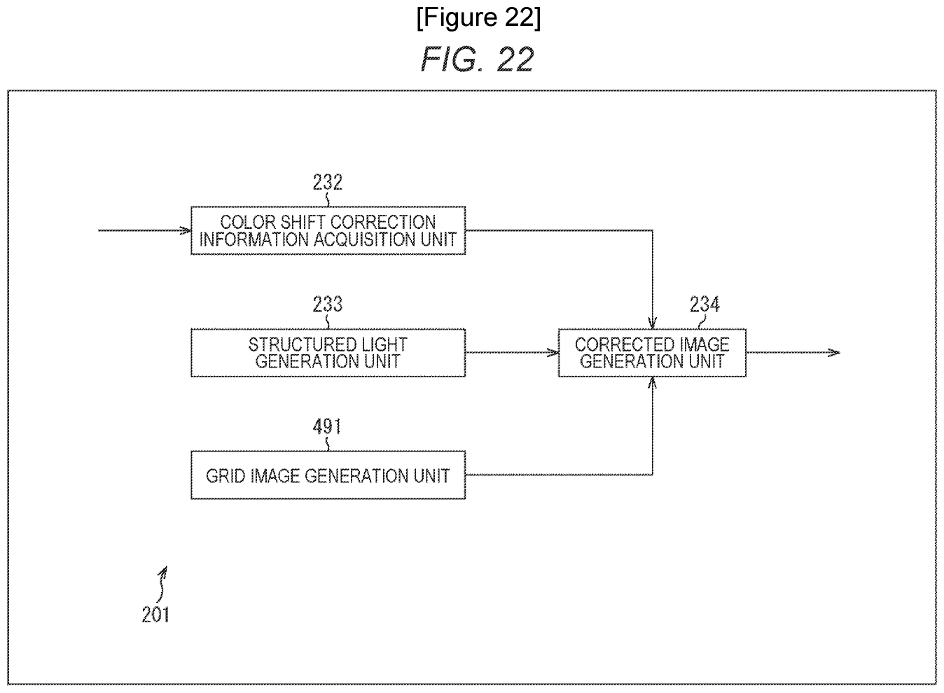

FIG. 23 is a block diagram illustrating a main configuration example of a camera.

FIG. 24 is a functional block diagram illustrating an example of main functions achieved by the information processing unit.

FIG. 25 is a flowchart illustrating an example of a flow of the color shift correction processing.

FIG. 26 is a flowchart illustrating an example of a flow of the color shift correction processing.

FIG. 27 is a view illustrating an example of a state of projection and imaging.

FIG. 28 is a functional block diagram illustrating an example of main functions achieved by the information processing unit.

FIG. 29 is a flowchart illustrating an example of a flow of the color shift correction processing.

FIG. 30 is a block diagram illustrating a main configuration example of the projection imaging system.

FIG. 31 is a view illustrating an example of a state of projection and imaging.

FIG. 32 is a view illustrating an example of a state of projection and imaging.

FIG. 33 is a view illustrating an example of a state of projection and imaging.

FIG. 34 is a functional block diagram illustrating an example of main functions achieved by the information processing unit.

FIG. 35 is a functional block diagram illustrating an example of main functions achieved by the information processing unit.

FIG. 36 is a flowchart illustrating an example of a flow of the color shift correction processing.

### MODE FOR CARRYING OUT THE INVENTION

Hereinafter, modes for carrying out the present disclosure (hereinafter referred to as embodiments) will be described. Note that the description will be made in the following order.
1. Color shift correction
2. First embodiment (projection imaging system)
3. Second embodiment (projection imaging system)
4. Third embodiment (projection imaging system)
5. Appendix

### 1. COLOR SHIFT CORRECTION

<Color Shift>

Conventionally, there has been a projection device (what is called a multi-plate projector) that projects light using an optical device such as a liquid crystal panel for each wavelength region component (so to speak, for each color). For example, there has been a three-plate projector that projects RGB light using optical devices different from each other.

In such a multiple-plate projector, even if RGB panels are fixed with high accuracy at the time of manufacture, a slight shift occurs between the RGB panels due to impact and aging, and consequently, a shift occurs in RGB light beams of the same pixel projected on the screen, which may cause color shift.

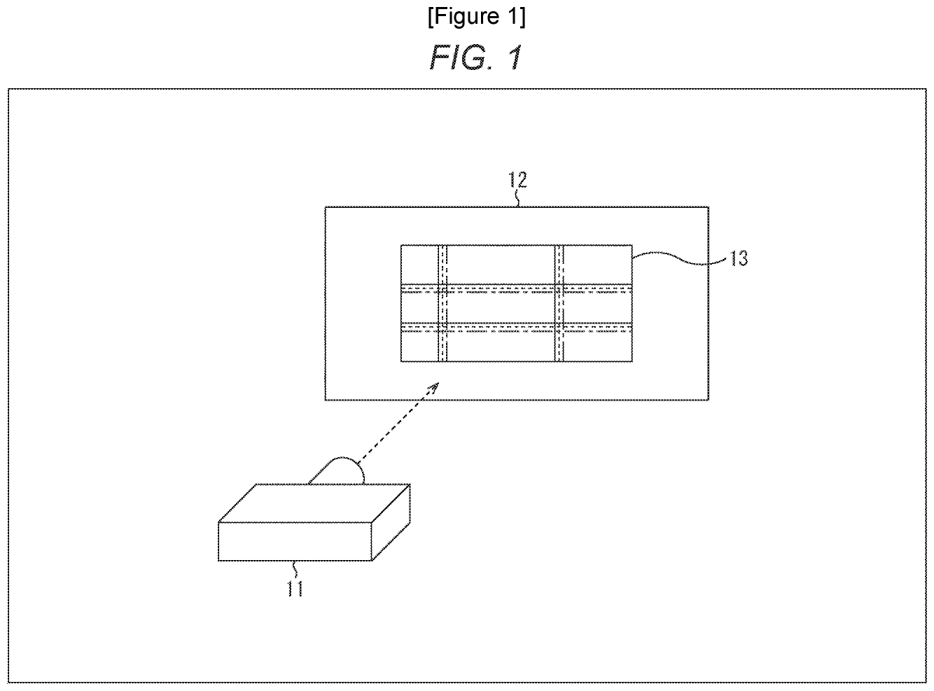

For example, as illustrated in FIG. 1, it is assumed that a three-plate projector 11 projects a projection image 13 including RGB light onto a screen 12. At this time, when a projection position using the R panel (the position of the projection image 13 on the screen), a projection position using the G panel, and a projection position using the B panel are shifted from each other, as illustrated in FIG. 1, in the projection image 13, an R line (for example, a solid line in the projection image 13), a G line (for example, a dotted line in the projection image 13), and a B line (for example, a one dot chain line in the projection image 13), which are supposed to be originally projected at the same positions, are projected at different positions. When such a color shift occurs, positions of respective colors of the projection image 13 appear to be shifted from each other, and thus subjective quality (image quality recognized by the user) of the projection image 13 may be reduced.

Such color shift (also referred to as registration shift) has been generally adjusted manually using a remote controller or the like. However, such an adjustment method requires a high degree of expertise and skill. Therefore, it is substantially difficult for a general user to perform adjustment. Even if the user has high expertise, complicated work is required to correct the color shift with high accuracy.

Accordingly, for example, an interpolation method has been considered in which an RGB shift is detected and color shift correction is performed by a 2D approach (2D signal processing) that captures appearance of a camera (linearity such as crosshatch projected on a flat screen) as described in Non-Patent Document 1.

However, this method can be applied only to a case of a flat screen because of the linearity of a measurement pattern such as crosshatch. Thus, it has been difficult to cope with projection onto a curved screen, displacement in a depth direction, and the like. In reality, the shape of a screen is less likely to be an ideal plane, and a shift may also occur in the depth direction. That is, the color shift generally occurs three-dimensionally. Therefore, complicated work such as manual adjustment has been required.

<Color Shift Correction Based on 3D Position>

Accordingly, the color shift is corrected on the basis of a 3D projection position of each optical device of a projection unit that projects RGB light using optical devices different from each other.

For example, an information processing device includes a color shift correction unit that corrects a color shift on the basis of a 3D projection position of each optical device of a projection unit that projects RGB light using optical devices different from each other.

By doing so, even in the case of a three-dimensional color shift, the color shift can be corrected more easily.

### 2. FIRST EMBODIMENT

<Projection Imaging System>

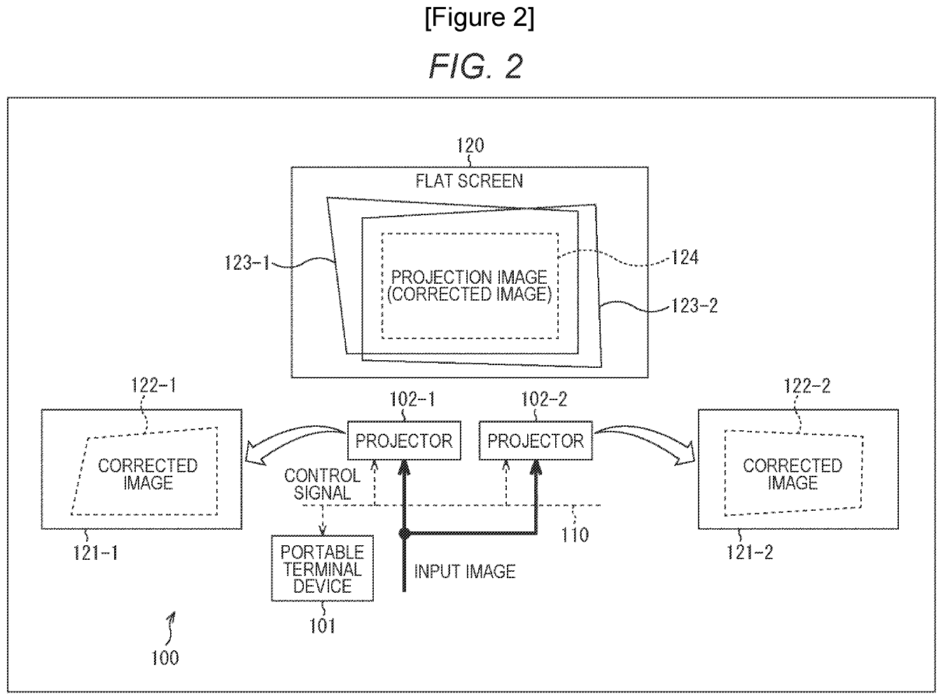

FIG. 2 is a block diagram illustrating a main configuration example of a projection imaging system which is one embodiment of an information processing system to which the present technology is applied. In FIG. 2, a projection imaging system 100 includes a portable terminal device 101, a projector 102-1, and a projector 102-2, and is a system that projects an image on a screen 120 or captures an image of the screen 120.

The portable terminal device 101, the projector 102-1, and the projector 102-2 are communicably connected to each other via a communication path 110. The communication path 110 is arbitrary, and may be either wired or wireless. For example, the portable terminal device 101, the projector 102-1, and the projector 102-2 can exchange control signals, image data, and the like via the communication path 110.

The portable terminal device 101 is one embodiment of an information processing device to which the present technology is applied, and is, for example, a device that can be carried by a user, such as a smartphone, a tablet terminal, or a notebook personal computer. The portable terminal device 101 has a communication function, an information processing function, and an imaging function. For example, the portable terminal device 101 may control image projection by the projector 102-1 and the projector 102-2. Furthermore, the portable terminal device 101 can correct color shift of the projector 102-1 and the projector 102-2. Moreover, the portable terminal device 101 can capture a projection image projected on the screen 120 by the projector 102-1 or the projector 102-2.

The projector 102-1 and the projector 102-2 are one embodiment of an information processing device to which the present technology is applied, and are projection devices that project images. The projector 102-1 and the projector 102-2 are similar devices to each other. Hereinafter, the projector 102-1 and the projector 102-2 will be referred to as a projector 102 in a case where it is not necessary to distinguish them from each other for description. For example, the projector 102 can project an input image on the screen 120 in accordance with control of the portable terminal device 101.

The projector 102-1 and the projector 102-2 can project images in cooperation with each other. For example, the projector 102-1 and the projector 102-2 can project images at the same position as each other to achieve high luminance of the projection image. Furthermore, the projector 102-1 and the projector 102-2 can project images such that the projection images thereof are arranged adjacent to each other, form one image by two projection images, and achieve a large screen (high resolution) of the projection image. In addition, the projector 102-1 and the projector 102-2 can also project an image such that a part of the projection image of each other is superimposed or the other projection image is included in one projection image. By performing projection in cooperation in this manner, the projector 102-1 and the projector 102-2 can achieve not only high luminance and a large screen but also, for example, a high dynamic range, a high frame rate, and the like of the projection image.

In such image projection, the projector 102 can geometrically correct an image to be projected under control of the portable terminal device 101, and the projection image can be superimposed at a correct position.

For example, as illustrated in FIG. 2, the projector 102-1 geometrically corrects an image 121-1 like a corrected image 122-1, and the projector 102-2 geometrically corrects an image 121-2 like a corrected image 122-2. Then, the projector 102-1 projects the image 121-1 including the corrected image 122-1, and the projector 102-2 projects the image 121-2 including the corrected image 122-2.

On the screen 120, a projection image 123-1 projected by the projector 102-1 and a projection image 123-2 projected by the projector 102-2 are superimposed on each other. By the geometric correction described above, the corrected image 122-1 and the corrected image 122-2 are projected at the same position as each other (in a rectangular state) without causing distortion in the portion where the projection image 123-1 and the projection image 123-2 are superimposed on each other. Thus, a high-luminance projection image 124 (a projection image of the corrected image 122-1 and a projection image of the corrected image 122-2 are superimposed) is achieved.

Note that the projector 102 is a three-plate projector that projects RGB light using optical devices different from each other. That is, the projector 102 is a projection device (what is called a multi-plate projector) that projects light using an optical device such as a liquid crystal panel for each wavelength region component (so to speak, for each color).

The screen 120 may be a flat screen or a curved screen.

In such a projection imaging system 100, the portable terminal device 101 can correct a three-dimensional color shift generated in the projector 102.

Note that, in FIG. 2, the projection imaging system 100 includes one portable terminal device 101 and two projectors 102, but the number of each device is arbitrary and is not limited to this example. For example, the projection imaging system 100 may include a plurality of portable terminal devices 101 or may include three or more projectors 102. Furthermore, the portable terminal device 101 may be configured integrally with any of the projectors 102.

<Portable Terminal Device>

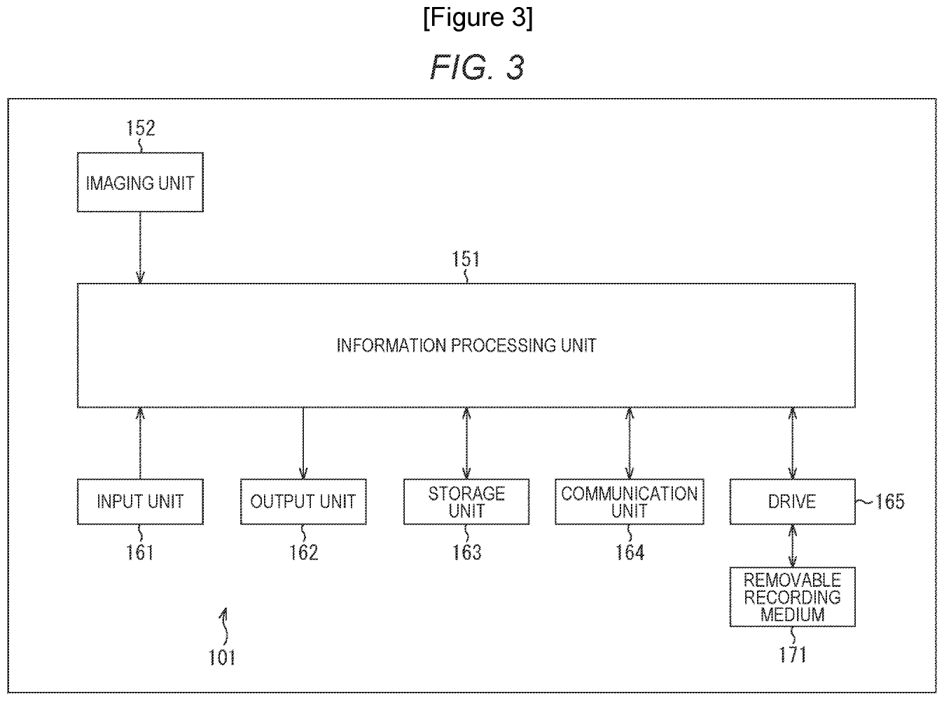

FIG. 3 is a diagram illustrating a main configuration example of a portable terminal device 101 which is one embodiment of an information processing device to which the present technology is applied. As illustrated in FIG. 3, the portable terminal device 101 includes an information processing unit 151, an imaging unit 152, an input unit 161, an output unit 162, a storage unit 163, a communication unit 164, and a drive 165.

The information processing unit 151 includes, for example, a central processing unit (CPU), a read only memory (ROM), a random access memory (RAM), and the like, and is a computer that can achieve various functions by executing an application program (software) using the CPU, the ROM, the RAM, and the like. For example, the information processing unit 151 can install and execute an application program (software) that performs processing related to correction of color shift. Here, the computer includes a computer incorporated in dedicated hardware, a general-purpose personal computer for example that can execute various functions by installing various programs, and the like.

The imaging unit 152 includes an optical system, an image sensor, and the like, and can image a subject and generate a captured image. The imaging unit 152 can supply the generated captured image to the information processing unit 151.

The input unit 161 includes, for example, input devices such as a keyboard, a mouse, a microphone, a touch panel, and an input terminal, and can supply information input via these input devices to the information processing unit 151.

The output unit 162 includes, for example, output devices such as a display (display unit), a speaker (audio output unit), and an output terminal, and can output the information supplied from the information processing unit 151 via these output devices.

The storage unit 163 includes, for example, a storage medium such as a hard disk, a RAM disk, or a non-volatile memory, and can store the information supplied from the information processing unit 151 in the storage medium. The storage unit 163 can read information stored in the storage medium and supply the information to the information processing unit 151.

The communication unit 164 includes, for example, a network interface, can receive information transmitted from another device, and can supply the received information to the information processing unit 151. The communication unit 164 can transmit the information supplied from the information processing unit 151 to another device.

The drive 165 has an interface of a removable recording medium 171 such as a magnetic disk, an optical disk, a magneto-optical disk, or a semiconductor memory, and can read information recorded on the removable recording medium 171 mounted on itself and supply the information to the information processing unit 151. The drive 165 can record the information supplied from the information processing unit 151 in the writable removable recording medium 171 mounted on itself.

For example, the information processing unit 151 loads and executes an application program stored in the storage unit 163. At that time, the information processing unit 151 can appropriately store data and the like necessary for executing various types of processing. The application program, data, and the like can be provided by being recorded in the removable recording medium 171 as a package medium or the like, for example. In that case, the application program, data, and the like are read by the drive 165 on which the removable recording medium 171 is mounted, and are installed in the storage unit 163 via the information processing unit 151. Furthermore, this application program can also be provided via a wired or wireless transmission medium such as a local area network, the Internet, or digital satellite broadcasting. In this case, the application program, data, and the like are received by the communication unit 164 and installed in the storage unit 163 via the information processing unit 151. Furthermore, the application program, data, and the like can be installed in advance in the ROM or the storage unit 163 in the information processing unit 151.

<Functional Block of Portable Terminal Device>

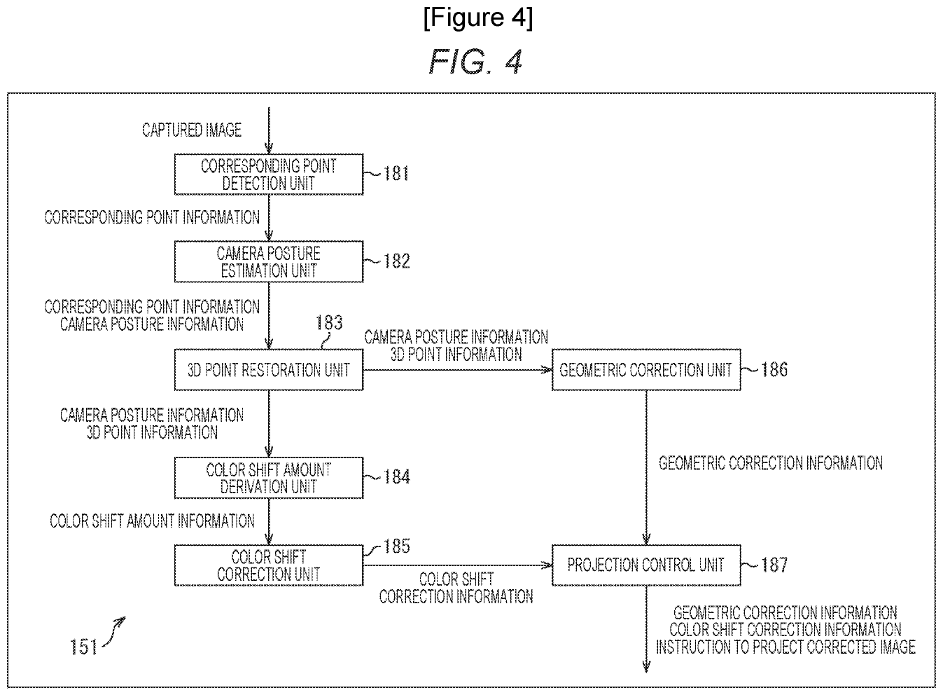

Functions implemented by the information processing unit 151 executing an application program are illustrated in FIG. 4 as functional blocks. As illustrated in FIG. 4, the information processing unit 151 can include, as the functional blocks, a corresponding point detection unit 181, a camera posture estimation unit 182, a 3D point restoration unit 183, a color shift amount derivation unit 184, a color shift correction unit 185, a geometric correction unit 186, and a projection control unit 187 by executing the application program.

The corresponding point detection unit 181 detects a corresponding point for each captured image on the basis of the captured image of the projection image projected on the screen 120. The corresponding point detection unit 181 supplies corresponding point information indicating the detected corresponding point to the camera posture estimation unit 182.

The camera posture estimation unit 182 estimates the posture of the camera corresponding to the captured image on the basis of the corresponding point information. The camera posture estimation unit 182 supplies camera posture information indicating the estimated posture to the 3D point restoration unit 183 together with the corresponding point information.

The 3D point restoration unit 183 restores the position (also referred to as a 3D position or a 3D point) of each pixel of the projection image in the three-dimensional space on the basis of the corresponding point information and the camera posture information. That is, the 3D point indicates a position (also referred to as a projection position) where each pixel of the image to be projected is projected three-dimensionally (in the three-dimensional space). This three-dimensional projection position is also referred to as a 3D projection position. The 3D point restoration unit 183 supplies 3D point information indicating the position (3D projection position) of the restored 3D point to the color shift amount derivation unit 184 and the geometric correction unit 186 together with the camera posture information.

The color shift amount derivation unit 184 derives a color shift amount indicating the magnitude and direction of the shift of each panel of the projector 102 in the three-dimensional space on the basis of the information. That is, the color shift amount is a vector that three-dimensionally indicates the color shift. The color shift amount derivation unit 184 supplies color shift information indicating the color shift amount to the color shift correction unit 185.

The color shift correction unit 185 three-dimensionally performs color shift correction in such a manner that the color shift is reduced on the basis of color shift amount information. That is, the color shift correction unit 185 corrects the color shift on the basis of the 3D projection position. Thus, the color shift correction unit 185 can correct the three-dimensional color shift. For example, the color shift correction unit 185 shifts the position of the projection image of each panel to reduce the color shift. The color shift correction unit 185 supplies color shift correction information, which is control information for the color shift correction, to the projection control unit 187.

On the basis of the camera posture information, the 3D point information, and the like, the geometric correction unit 186 derives a way of geometric correction of the image to be projected in order to make the position, shape, and the like of the projection image appropriate. The geometric correction unit 186 generates geometric correction information, which is a parameter indicating how to perform the geometric correction, and supplies the geometric correction information to the projection control unit 187.

The projection control unit 187 supplies the geometric correction information and the color shift correction information to the control target the projector 102. Furthermore, the projection control unit 187 supplies an instruction to project the corrected image to the projector 102 to project the corrected image.

<Projector>

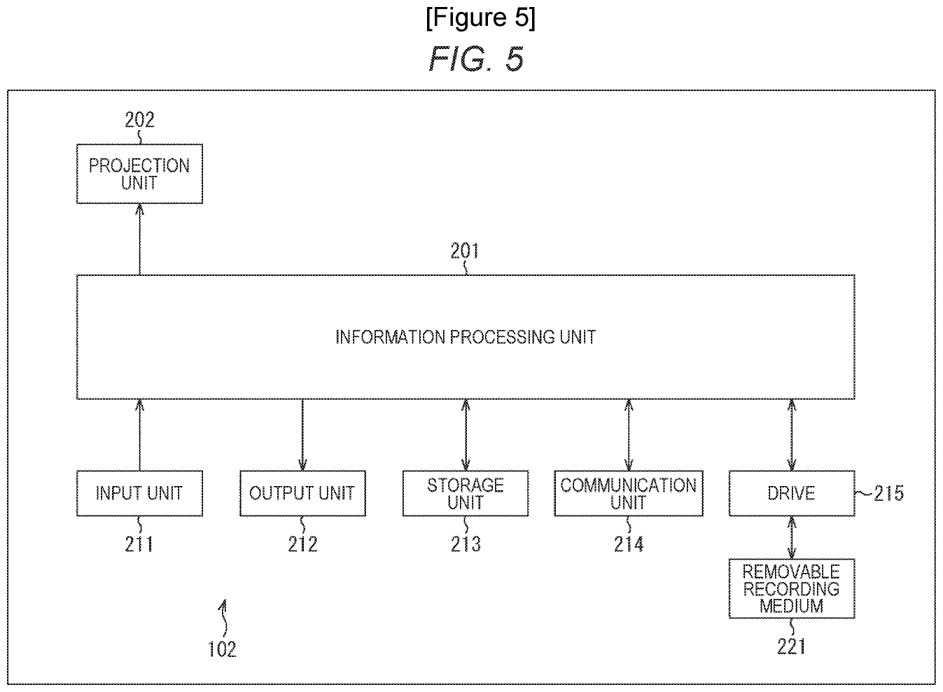

FIG. 5 is a diagram illustrating a main configuration example of the projector 102 which is one embodiment of an information processing device to which the present technology is applied. As illustrated in FIG. 5, the projector 102 includes an information processing unit 201, a projection unit 202, an input unit 211, an output unit 212, a storage unit 213, a communication unit 214, and a drive 215.

The information processing unit 201 is a computer that includes, for example, a CPU, a ROM, a RAM, and the like, and can implement various functions by executing an application program (software) using the CPU, the ROM, the RAM, and the like. For example, the information processing unit 201 can install and execute an application program (software) that performs processing related to image projection. Here, the computer includes a computer incorporated in dedicated hardware, a general-purpose personal computer for example that can execute various functions by installing various programs, and the like.

The projection unit 202 includes an optical device, a light source, and the like, and can project a desired image under the control of the information processing unit 201. For example, the projection unit 202 can project the image supplied from the information processing unit 201.

The input unit 211 includes, for example, input devices such as a keyboard, a mouse, a microphone, a touch panel, and an input terminal, and can supply information input via these input devices to the information processing unit 201.

The output unit 212 includes, for example, output devices such as a display (display unit), a speaker (audio output unit), and an output terminal, and can output the information supplied from the information processing unit 201 via these output devices.

The storage unit 213 includes, for example, a storage medium such as a hard disk, a RAM disk, or a non-volatile memory, and can store the information supplied from the information processing unit 201 in the storage medium. The storage unit 213 can read information stored in the storage medium and supply the information to the information processing unit 201.

The communication unit 214 can include, for example, a network interface, can receive information transmitted from another device, and can supply the received information to the information processing unit 201. The communication unit 214 can transmit the information supplied from the information processing unit 201 to another device.

The drive 215 has an interface of a removable recording medium 221 such as a magnetic disk, an optical disk, a magneto-optical disk, or a semiconductor memory, and can read information recorded on the removable recording medium 221 mounted on itself and supply the information to the information processing unit 201. The drive 215 can record the information supplied from the information processing unit 201 in the writable removable recording medium 221 mounted on itself.

For example, the information processing unit 201 loads and executes an application program stored in the storage unit 213. At that time, the information processing unit 201 can appropriately store data and the like necessary for executing various types of processing. The application program, data, and the like can be provided by being recorded in the removable recording medium 221 as a package medium or the like, for example. In that case, the application program, data, and the like are read by the drive 215 on which the removable recording medium 221 is mounted, and are installed in the storage unit 213 via the information processing unit 201. Furthermore, this application program can also be provided via a wired or wireless transmission medium such as a local area network, the Internet, or digital satellite broadcasting. In this case, the application program, data, and the like are received by the communication unit 214 and installed in the storage unit 213 via the information processing unit 201. Furthermore, the application program, data, and the like can be installed in advance in the ROM or the storage unit 213 in the information processing unit 201.

<Functional Block of Projector>

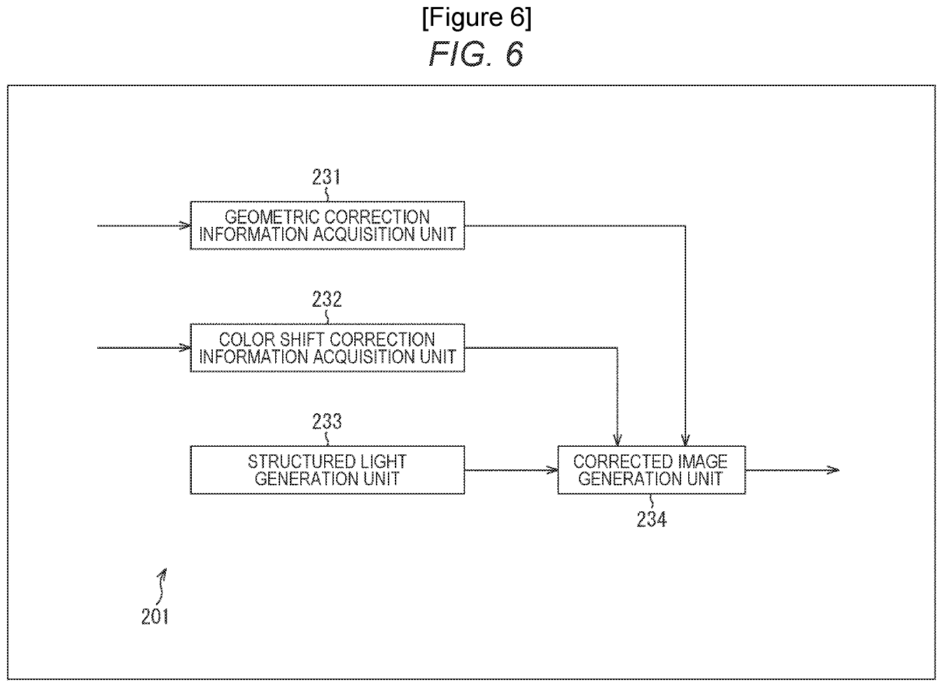

Functions implemented by the information processing unit 201 executing an application program are illustrated in FIG. 6 as functional blocks. As illustrated in FIG. 6, the information processing unit 201 can include a geometric correction information acquisition unit 231, a color shift correction information acquisition unit 232, a structured light generation unit 233, and a corrected image generation unit 234 as the functional blocks by executing the application program.

The geometric correction information acquisition unit 231 acquires the geometric correction information supplied from the portable terminal device 101, and supplies the geometric correction information to the corrected image generation unit 234.

The color shift correction information acquisition unit 232 acquires the color shift correction information supplied from the portable terminal device 101 and supplies the color shift correction information to the corrected image generation unit 234.

The structured light generation unit 233 generates structured light that is a predetermined pattern image, and supplies the structured light to the corrected image generation unit 234.

The corrected image generation unit 234 corrects the structured light and generates a corrected image on the basis of the control of the portable terminal device 101. For example, the corrected image generation unit 234 performs the color shift correction on the structured light on the basis of the color shift correction information, performs geometric correction on the basis of the geometric correction information, and generates a corrected image. The corrected image generation unit 234 supplies the corrected image to the projection unit 202, so that the corrected image is projected.

As described above, since the portable terminal device 101 corrects the color shift on the basis of the 3D projection position, it is possible to correct the three-dimensional color shift. Furthermore, the projector 102 can project a corrected image reflecting the color shift correction. Therefore, the projection imaging system 100 can correct the color shift more easily.

<Flow of Color Shift Correction Processing>

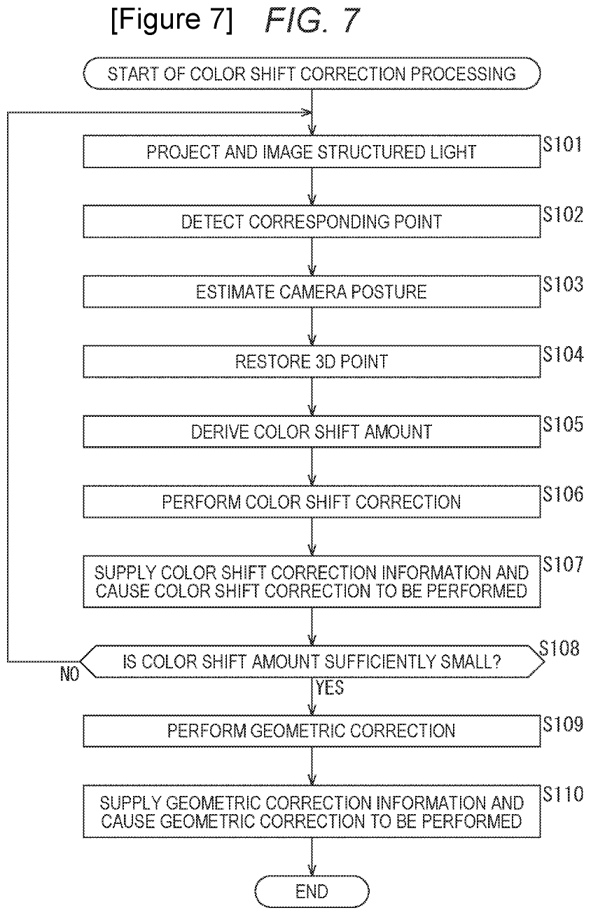

An example of a flow of color shift correction processing executed by the information processing unit 151 of the portable terminal device 101 will be described with reference to a flowchart of FIG. 7.

When the color shift correction processing is started, the projection control unit 187 controls the projector 102 to project the structured light in step S101.

On the basis of such control, the structured light generation unit 233 generates structured light of different colors (for example, Red/Blue) and causes the structured light to be projected from different optical devices (for example, panels) of the projection unit 202.

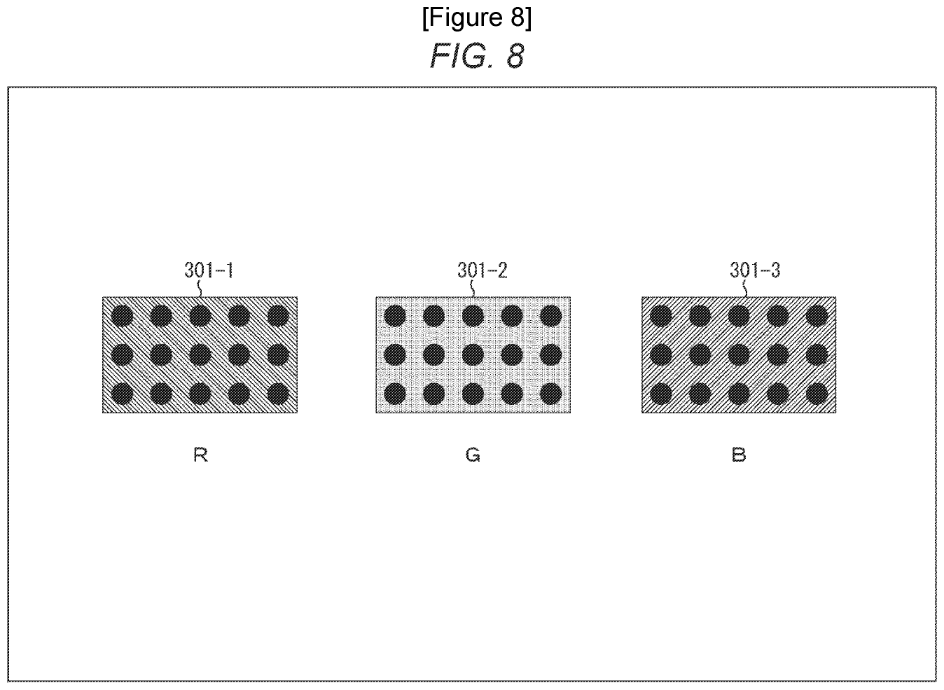

The structured light is a predetermined pattern image that can be projected from one optical device of the projection unit 202. For example, like structured light 301-1, structured light 301-2, and structured light 301-3 in FIG. 8, each structured light 301 has a similar pattern and is configured with different colors. The structured light 301-1 is a red (R) pattern image. The structured light 301-2 is a green (G) pattern image. The structured light 301-3 is a blue (B) pattern image.

The projector 102-1 and the projector 102-2 generate structured light of different colors among the structured light, and project the structured light from the respective projection units 202. Therefore, the projection image of the structured light is projected on the screen 120 so as to be superimposed on each other.

The imaging unit 152 of the portable terminal device 101 captures the projection image projected on the screen 120 on the basis of a user instruction or the like.

This operation is repeated while changing the color of the structured light and the imaging position. That is, the projector 102-1 and the projector 102-2 project (for example, the second time is Blue/Green, and the third time is Green/Red) structured light having different colors from each other and having a combination of colors different from the past. Then, the portable terminal device 101 captures the projection image at a position different from the previous capturing position.

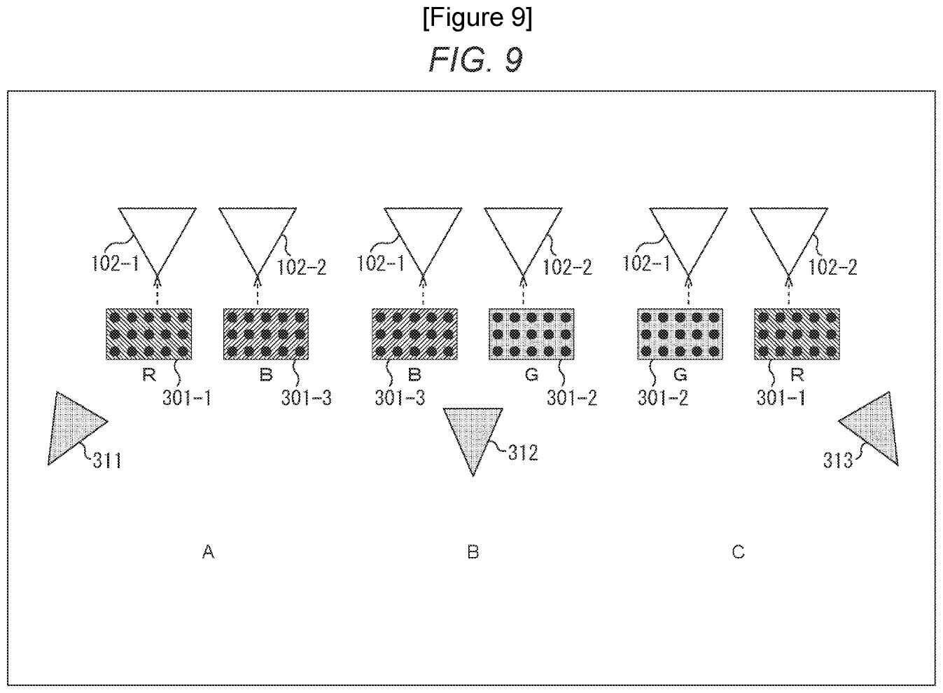

For example, in the first time, as illustrated in A of FIG. 9, the projector 102-1 projects the structured light 301-1 (R), the projector 102-2 projects the structured light 301-3 (B), and the imaging unit 152 of the portable terminal device 101 captures a projection image from the left side like a camera 311. In the second time, as illustrated in B of FIG. 9, the projector 102-1 projects the structured light 301-3 (B), the projector 102-2 projects the structured light 301-2 (G), and the imaging unit 152 of the portable terminal device 101 captures a projection image from the center like a camera 312. In the third time, as illustrated in C of FIG. 9, the projector 102-1 projects the structured light 301-2 (G), the projector 102-2 projects the structured light 301-1 (R), and the imaging unit 152 of the portable terminal device 101 captures a projection image from the right side like a camera 313.

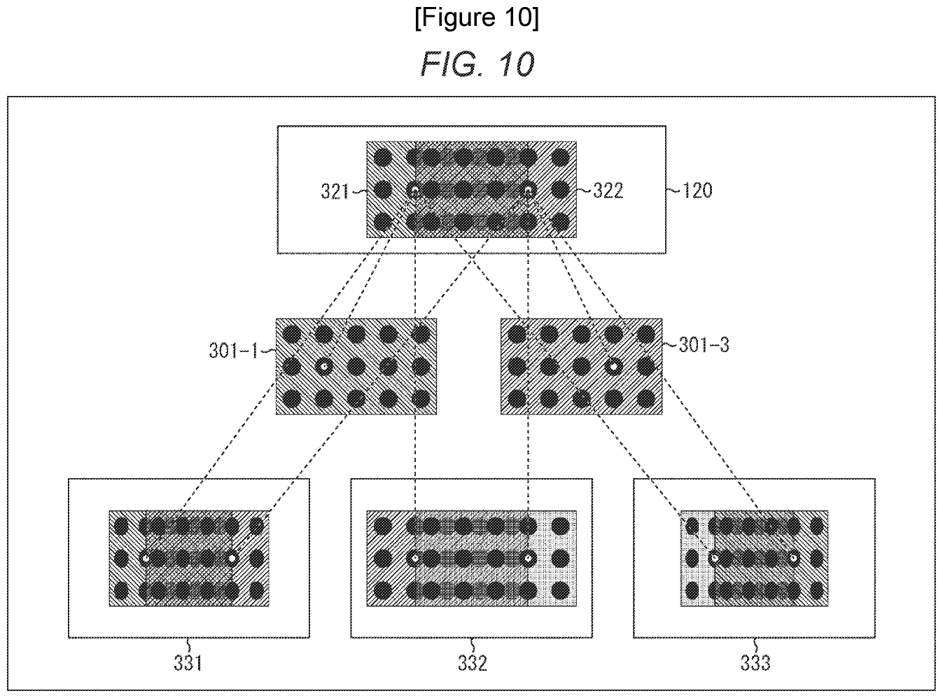

Next, in step S102, the corresponding point detection unit 181 detects the corresponding point on the basis of the captured image obtained by the imaging as described above. That is, as illustrated in FIG. 10, the corresponding point detection unit 181 detects points corresponding to each other, that is, points (pixels) displaying the same positions as each other of the structured light 301 in a captured image 331 captured at the position of the camera 311, a captured image 332 captured at the position of the camera 312, and a captured image 333 captured at the position of the camera 313 as corresponding points (for example, white circles in the drawing). The corresponding point detection unit 181 detects the corresponding point on the basis of a pattern of the projected structured light 301 (in the case of the example of FIG. 10, the structured light 301-1 and the structured light 301-3). That is, the corresponding point detection unit 181 detects corresponding points in a plurality of captured images obtained by capturing the projection images of respective colors from different positions.

Note that these captured images include a plurality of pieces of structured light 301 superimposed on each other. Therefore, the pattern of each structured light is separated, and the corresponding point is detected using the separated pattern. A method for separating this pattern is arbitrary. For example, a separate image for each color information may be generated on the basis of color information of a captured image obtained by capturing a mixed image of projection images projected from a plurality of projectors 102 with different color information assigned thereto, and a color model indicating a relationship between the color information of the captured image and color information of the projection images and the background.

The color model uses, as parameters, color information of the projection image changed according to spectral characteristics of the projection unit 202 and the imaging unit 152 that acquires the captured image, an attenuation coefficient indicating attenuation occurring in the mixed image captured by the imaging unit 152, and color information of the background. Accordingly, the separate image for each color information is generated on the basis of the color model using the parameter that minimizes the difference between the color information of the captured image and the color information estimated by the color model.

Note that the pattern of the structured light 301 used here may be any pattern as long as color separation and one-shot decoding are possible. Furthermore, in a case where the camera is fixedly installed by a tripod or the like instead of being held by hand, a pattern in which decoding is performed using information of a plurality of patterns in a time direction, such as Gray Code, may be used. In a case where the camera is fixed, processing of color separation is unnecessary, and the projector 102-1 and the projector 102-2 may project the structured light at different timings in terms of time.

The corresponding point detection unit 181 performs such corresponding point detection for combinations of respective colors. That is, the corresponding point detection unit 181 performs the corresponding point detection on the projection and imaging patterns of A, B, and C in FIG. 9 as described above. That is, the corresponding point detection unit 181 derives the captured images of the projection images of the respective colors for the respective projection units by separating the projection images in the plurality of captured images of the projection images of different combinations of colors.

In step S103, the camera posture estimation unit 182 estimates each posture (position and posture) of the cameras 311 to 313.

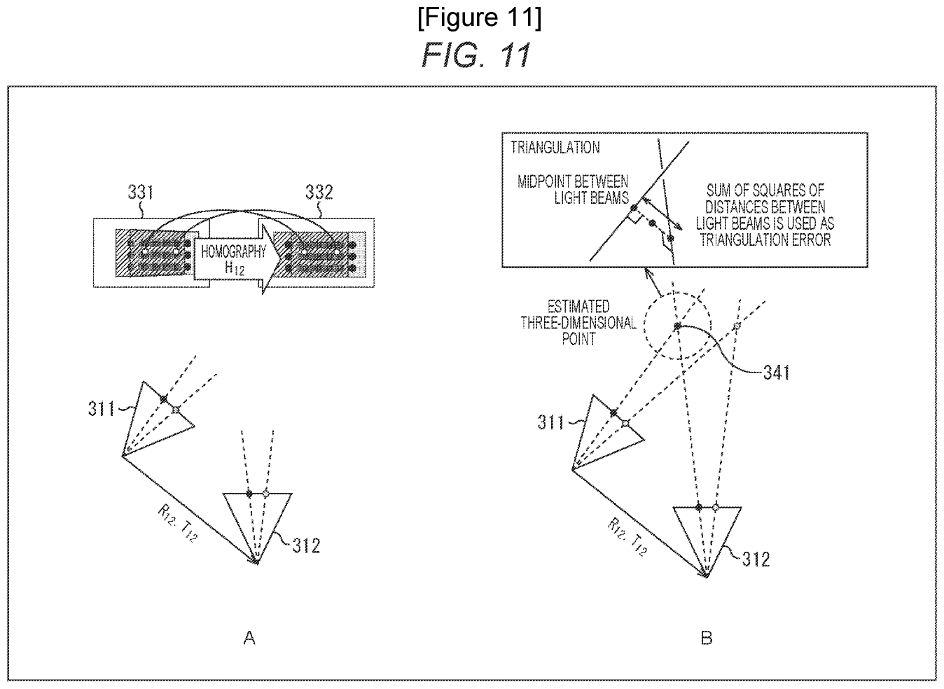

First, attention is paid to the corresponding point information of two camera images. For example, as illustrated in A of FIG. 11, in a case where attention is paid to the captured image 331 of the camera 311 of the left viewpoint and the captured image 332 of the front camera 312, a homography matrix (H₁₂) to be transformed from the corresponding point of the camera 311 of the left viewpoint to the corresponding point of the front camera 312 is obtained. Homography is obtained by random sample consensus (RANSAC), which is a robust estimation algorithm, so that even if an outlier exists at the corresponding point, the outlier is not greatly affected.

By performing RT decomposition on the homography matrix, the position and posture of the front camera with respect to the camera of the left viewpoint are obtained. As a method of the RT decomposition, for example, the method of “The Journal of the Institute of Image Electronics Engineers/40 Vol. (2011) 3 p. 421-427” is used. At this time, since the scale is indefinite, the scale is determined by some rule.

As illustrated in B of FIG. 11, the position and posture of the front camera 312 with respect to the camera 311 of the left viewpoint obtained here and their corresponding point information are triangulated to obtain three-dimensional points of the corresponding points. Here, when obtaining a three-dimensional point by triangulation, corresponding light beams may not intersect with each other. In this case, a midpoint (also referred to as a triangulation point) of a line segment that connects points at positions where the light beams are closest to each other (also referred to as nearest points) of the corresponding light beams is set as the three-dimensional point.

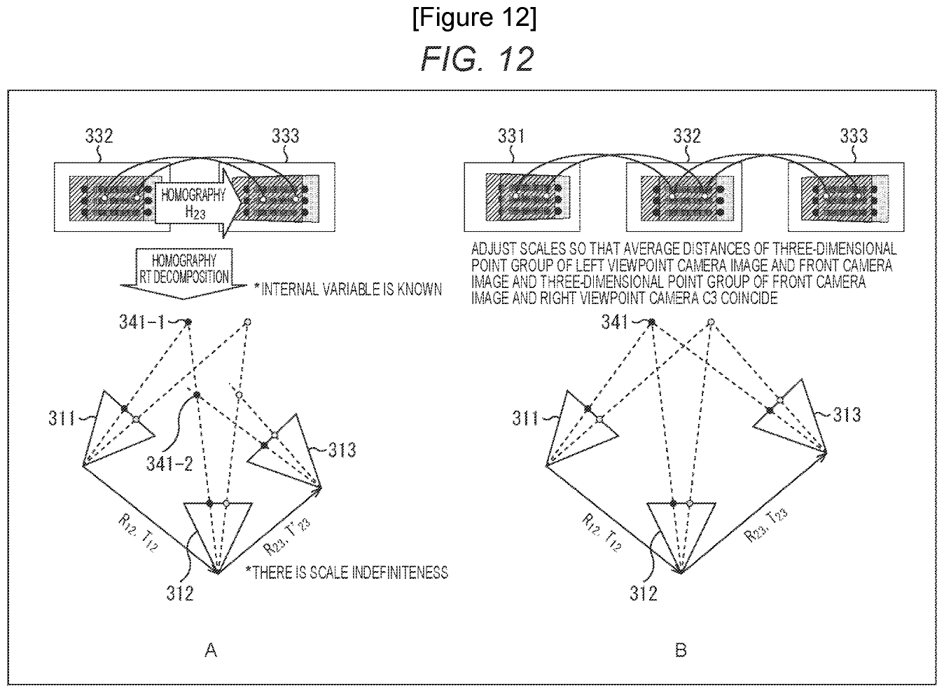

Next, as illustrated in A of FIG. 12, focusing on the front camera 312 and the camera 313 of the right viewpoint, similar processing is performed to obtain the position and posture of the camera 313 of the right viewpoint with respect to the front camera 312. Also at this time, since the scales of the front camera 312 and the camera 313 of the right viewpoint are indefinite, the scale is determined by some rules. Furthermore, from the corresponding points of the front camera 312 and the camera 313 of the right viewpoint, three-dimensional points corresponding thereto are obtained by triangulation.

Next, as illustrated in B of FIG. 12, the scales of the front camera 312 and the camera 313 of the right viewpoint are corrected so that the average distance from the camera of the three-dimensional points of the corresponding points obtained from the camera 311 of the left viewpoint and the front camera 312 obtained here coincides with the average distance from the camera of the three-dimensional points of the corresponding points obtained from the front camera 312 and the camera 313 of the right viewpoint. The scale is corrected by changing the lengths of the translation component vectors of the front camera 312 and the camera 313 of the right viewpoint.

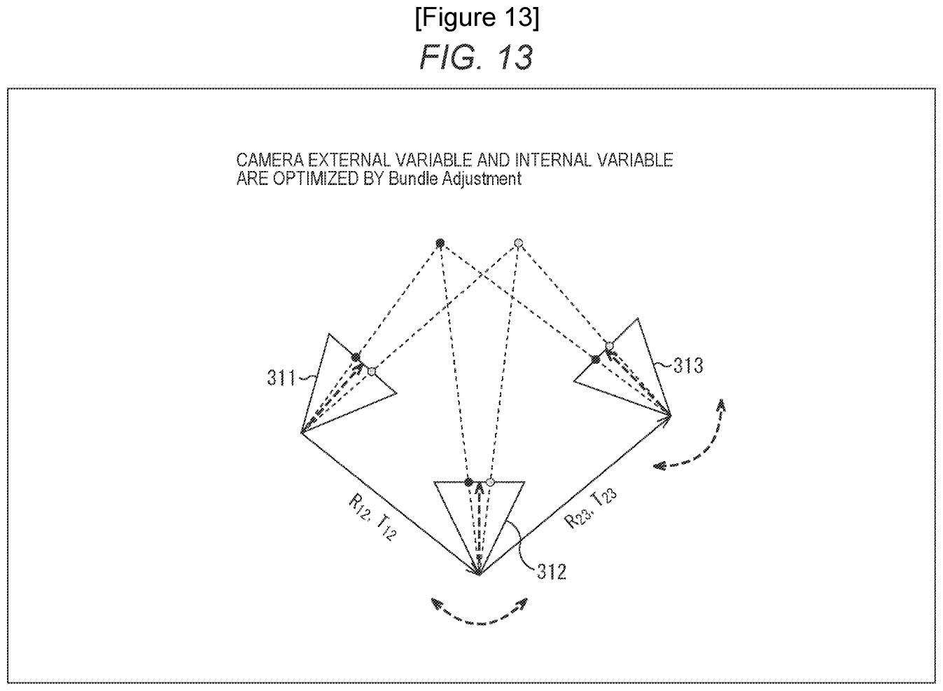

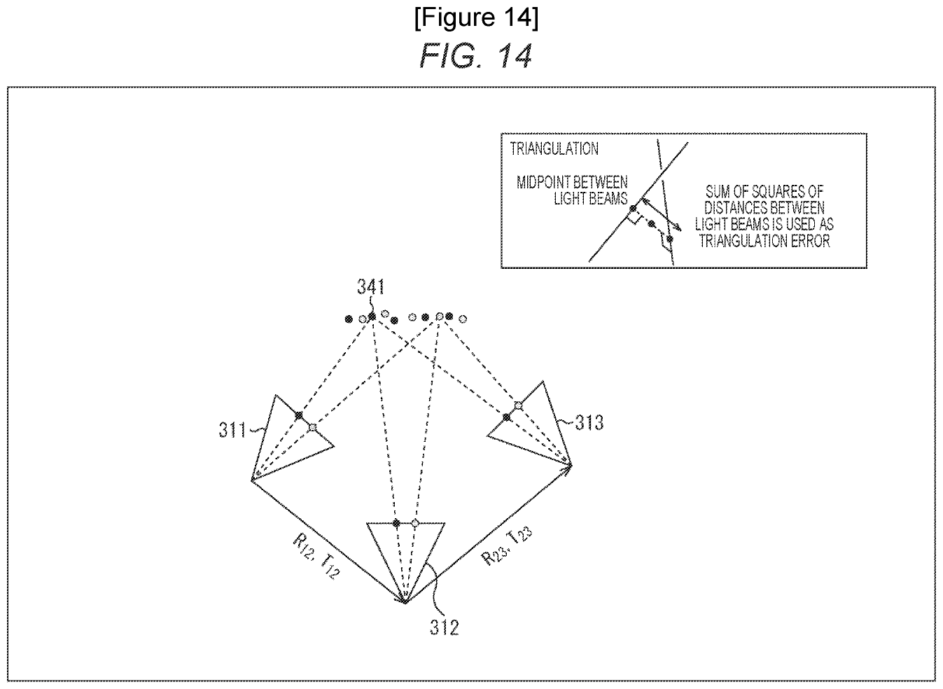

Finally, as illustrated in FIG. 13, the camera 311 of the left viewpoint is fixed as a reference, and the position and posture of the front camera 312 and the camera 313 of the right viewpoint are optimized by bundle adjustment that optimizes an internal parameter, an external parameter, and a world coordinate point group. At this time, the evaluation value is a sum of squares of distances from the three-dimensional point of the corresponding point to corresponding three light beams, and optimization is performed such that the sum of squares is minimized. Note that, as illustrated in FIG. 14, the three-dimensional corresponding points by the three light beams are centroid positions of triangulation points of corresponding light beams of the camera 311 of the left viewpoint and the front camera 312, triangulation points of corresponding light beams of the front camera 312 and the camera 313 of the right viewpoint, and triangulation points of corresponding light beams of the camera 313 of the right viewpoint and the camera 311 of the left viewpoint. Thus, the position and posture of the three cameras are estimated.

In step S104, the 3D point restoration unit 183 restores a 3D point 341, which is a 3D projection position of each pixel, as illustrated in FIG. 14 on the basis of the position and posture of each camera estimated as described above.

In step S105, the color shift amount derivation unit 184 derives the color shift amount. For example, the color shift amount derivation unit 184 defines a triangulation error at the time of 3D point restoration (sum of squares of distances between nearest contacts of respective light beams) as the magnitude of the color shift amount, defines a direction of a vector (for example, in an upper right quadrangular frame of FIG. 14, directions of arrows from a midpoint between light beams toward each light beam) connecting a triangulation point (in a case where there is a plurality of triangulation points as described above, a center of gravity thereof) and the nearest contacts of the respective light beams as a direction of the color shift amount, and derives the color shift amount.

In step S106, the color shift correction unit 185 performs the color shift correction so that (the magnitude of) the color shift amount derived in step S105 becomes small. A correction amount at that time may be a fixed value or may be adaptively variable. For example, the correction may be performed with the correction amount corresponding to the magnitude of the color shift amount. Furthermore, in a case where a surveying error between two light beams among the RGB light beams is small (for example, they intersect at approximately one point) but a surveying error with a remaining light beam is large, a method of correcting only a color component corresponding to the light beam can also be applied.

In step S107, the projection control unit 187 supplies the color shift correction information to each projector 102, and causes the projector 102 of the supply destination to perform the color shift correction.

In step S108, the color shift correction unit 185 determines whether or not (the magnitude of) the color shift amount is sufficiently small. In a case where it is determined that the color shift amount is large, the processing returns to step S101. Then, in a case where it is determined in step S107 that the color shift amount is sufficiently small, the processing proceeds to step S109.

That is, each process of steps S101 to S108 is repeatedly executed until it is determined in step S108 that the color shift amount is sufficiently small (for example, the RGB light beams are close to each other in the three-dimensional space (ideally intersect at one point)).

In step S109, the geometric correction unit 186 performs the geometric correction on each image so that the projection images projected from the respective projectors 102 are exactly superimposed on the screen 120.

In step S110, the projection control unit 187 supplies the geometric correction information to each projector 102, causes the projector 102 to which the geometric correction information is supplied to perform the geometric correction, and causes the projector to project the corrected image.

When the process of step S110 ends, the color shift correction processing ends.

By performing the color shift correction processing in this manner, the portable terminal device 101 can perform three-dimensional color shift correction. Therefore, the color shift can be corrected more easily.

Note that the definition of the color shift amount is arbitrary, and is not limited to the above example. For example, an error (reprojection error) between a 2D point obtained by reprojecting the restored 3D point on each camera image space and a camera corresponding point and a direction thereof may be defined as a color shift amount.

<Color Shift Correction by Geometric Correction>

Note that, instead of performing the color shift correction as described above, the geometric correction may be performed, and (the magnitude of) the color shift amount may be reduced by the geometric correction.

<Functional Block of Portable Terminal Device>

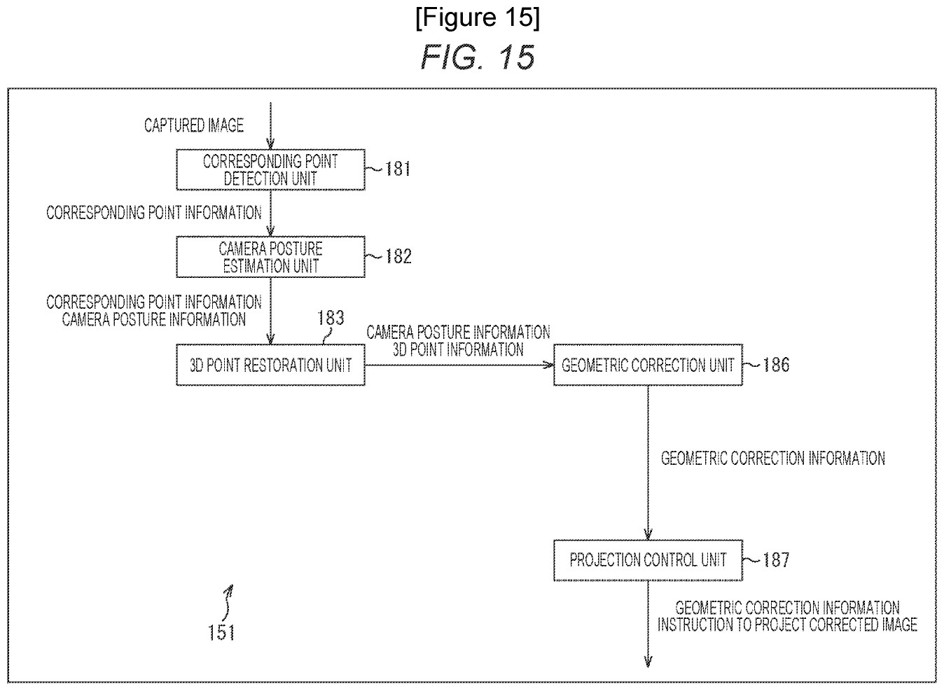

Functions implemented by the information processing unit 151 executing an application program in this case are illustrated in FIG. 15 as functional blocks. As illustrated in FIG. 15, the information processing unit 151 in this case can include the corresponding point detection unit 181, the camera posture estimation unit 182, the 3D point restoration unit 183, the geometric correction unit 186, and the projection control unit 187 as the functional blocks by executing the application program. That is, the color shift amount derivation unit 184 and the color shift correction unit 185 can be omitted as compared with the configuration in the case of FIG. 4. In this case, the geometric correction unit 186 performs the geometric correction to reduce the color shift amount.

<Functional Block of Projector>

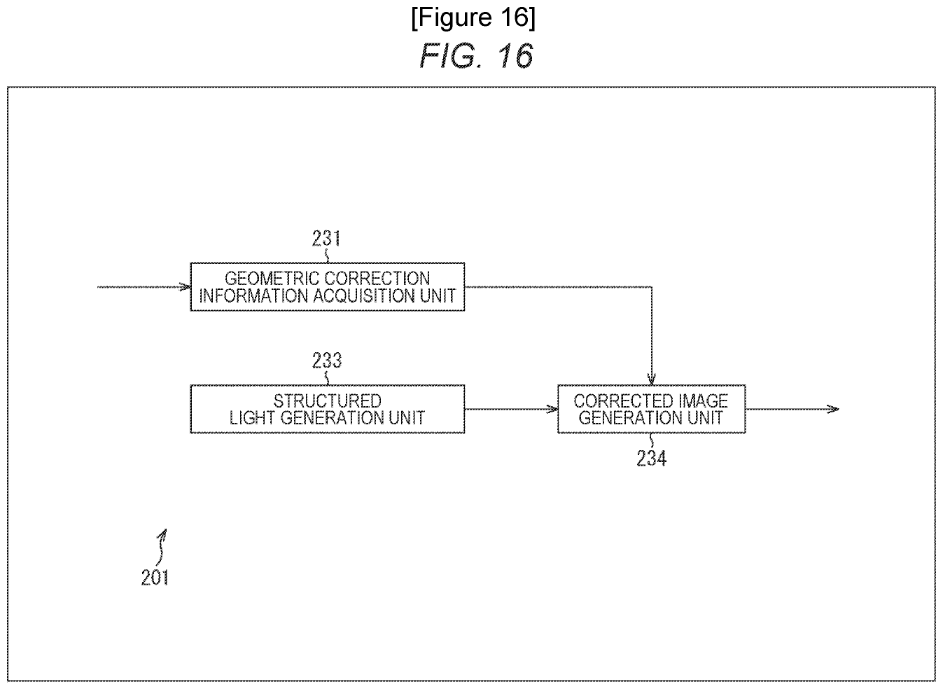

Functions implemented by the information processing unit 201 executing an application program in this case are illustrated in FIG. 16 as functional blocks. As illustrated in FIG. 16, the information processing unit 201 in this case can include the geometric correction information acquisition unit 231, the structured light generation unit 233, and the corrected image generation unit 234 as the functional blocks by executing the application program. That is, the color shift correction information acquisition unit 232 can be omitted as compared with the configuration in the case of FIG. 6. In this case, the corrected image generation unit 234 performs the geometric correction on the basis of the geometric correction information, thereby reducing the color shift amount.

Therefore, the portable terminal device 101 can more easily correct the color shift.

<Flow of Color Shift Correction Processing>

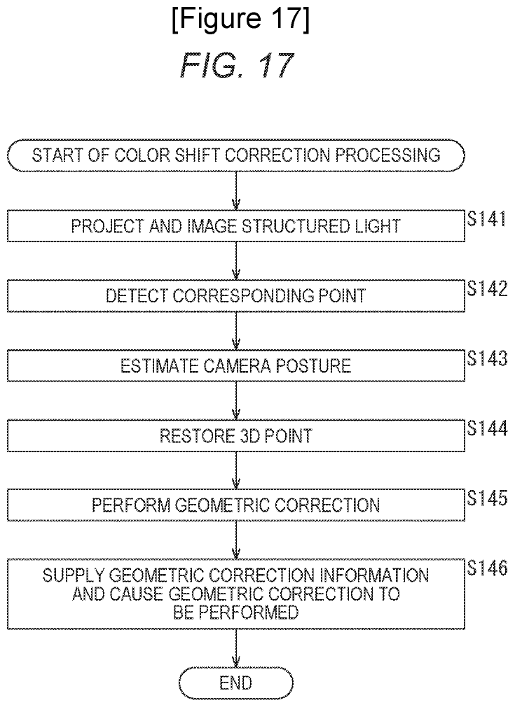

An example of a flow of the color shift correction processing executed by the information processing unit 151 of the portable terminal device 101 in this case will be described with reference to a flowchart of FIG. 17.

When the color shift correction processing is started, each process of steps S141 to S144 is executed similarly to each process of steps S101 to S104 of FIG. 7. Then, each process of steps S145 and S146 are executed similarly to each process of steps S109 and S110 in FIG. 7. When the process of step S146 ends, the color shift correction processing ends.

Therefore, the portable terminal device 101 can more easily correct the color shift.

### 3. SECOND EMBODIMENT

<Projection Imaging System>

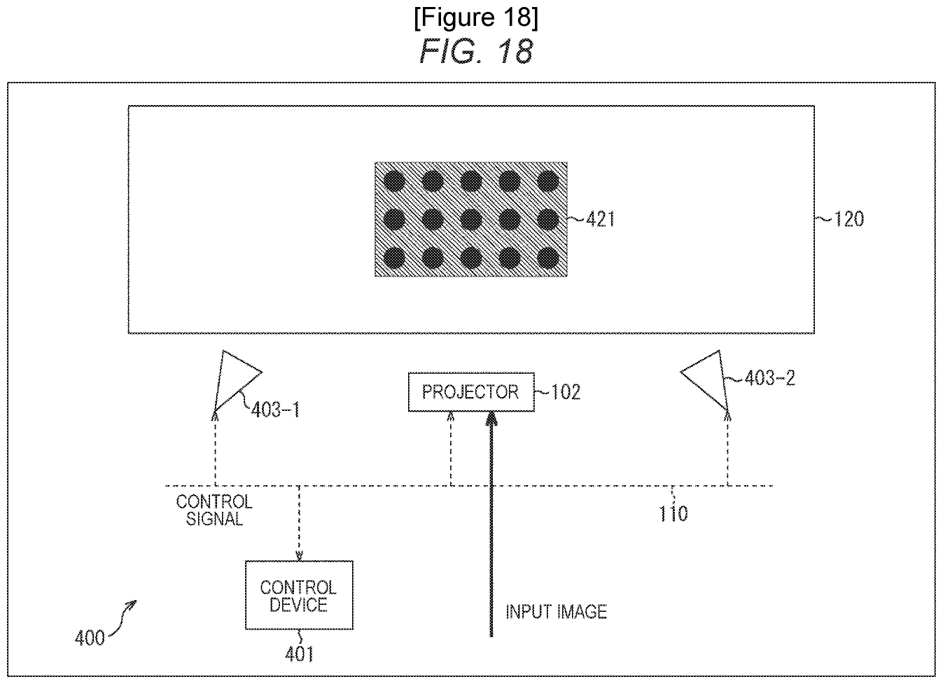

The corresponding point detection may be performed for each color (that is, for each structured light beam). FIG. 18 is a block diagram illustrating a main configuration example of a projection imaging system which is one embodiment of an information processing system to which the present technology is applied. Similarly to the projection imaging system 100 in FIG. 2, a projection imaging system 400 illustrated in FIG. 18 is a system that projects an image on the screen 120 or images the screen 120, and is a system that can perform the color shift correction.

The projection imaging system 400 includes the projector 102, a control device 401, a camera 403-1, and a camera 403-2. The projector 102, the control device 401, the camera 403-1, and the camera 403-2 are communicably connected to each other via the communication path 110. As in the case of FIG. 2, the communication path 110 is arbitrary, and may be either wired or wireless. For example, the projector 102, the control device 401, the camera 403-1, and the camera 403-2 can exchange control signals, image data, and the like via the communication path 110.

The projector 102 can project an input image on the screen 120 in accordance with control of the control device 401, for example. For example, a projection image 421 of structured light is projected on the screen 120 by projection of the projector 102.

The control device 401 can control the projection by controlling the projector 102, and can control the imaging by controlling the camera 403-1 and the camera 403-2. For example, the control device 401 can perform the color shift correction of the projector 102 on the basis of captured images captured by the camera 403-1 and the camera 403-2.

The camera 403-1 and the camera 403-2 are one embodiment of an information processing device to which the present technology is applied, and are devices that image a subject and generate a captured image. The camera 403-1 and the camera 403-2 capture the screen 120 (projection image 421 on the screen 120) from different positions. Note that the camera 403-1 and the camera 403-2 will be referred to as the camera 403 in a case where it is not necessary to distinguish them from each other for description.

Although FIG. 18 illustrates two cameras 403, the number of cameras 403 that images the screen 120 may be any number as long as it is two or more. However, the positions (and postures) of the cameras 403 are different from each other.

In such a projection imaging system 400, the control device 401 can correct the three-dimensional color shift generated in the projector 102 as in the case of the portable terminal device 101 of the projection imaging system 100.

However, in the case of the projection imaging system 400, the corresponding point detection is performed for each color (that is, for each structured light beam).

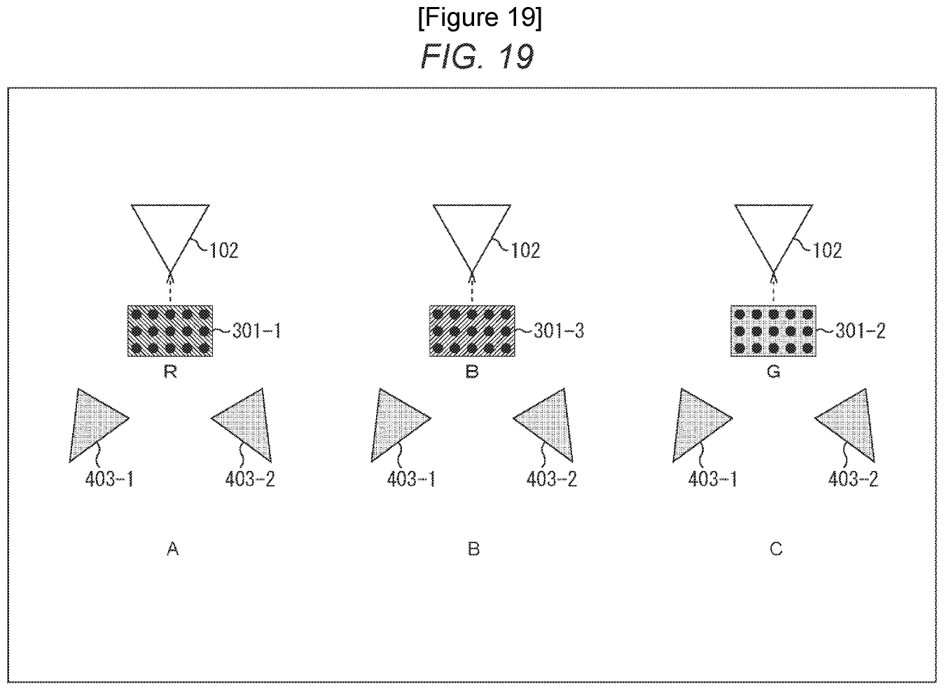

For example, in the first time, as illustrated in A of FIG. 19, the projector 102 projects the structured light 301-1 (R), and the camera 403-1 and the camera 403-2 capture projection images from the left and right as illustrated in the drawing. In the second time, as illustrated in B of FIG. 19, the projector 102 projects the structured light 301-3 (B), and the camera 403-1 and the camera 403-2 capture projection images from the left and right as illustrated in the drawing. In the third time, as illustrated in C of FIG. 19, the projector 102 projects the structured light 301-2 (G), and the camera 403-1 and the camera 403-2 capture projection images from the left and right as illustrated in the drawing.

In this manner, a plurality of captured images is generated at each time (that is, for each color of the structured light), and corresponding points are detected using the plurality of captured images.

Note that the number of projectors 102 is arbitrary. The projection imaging system 400 may include two or more projectors 102. In this case, the color shift correction of each projector 102 is performed independently (individually) from each other.

<Control Device>

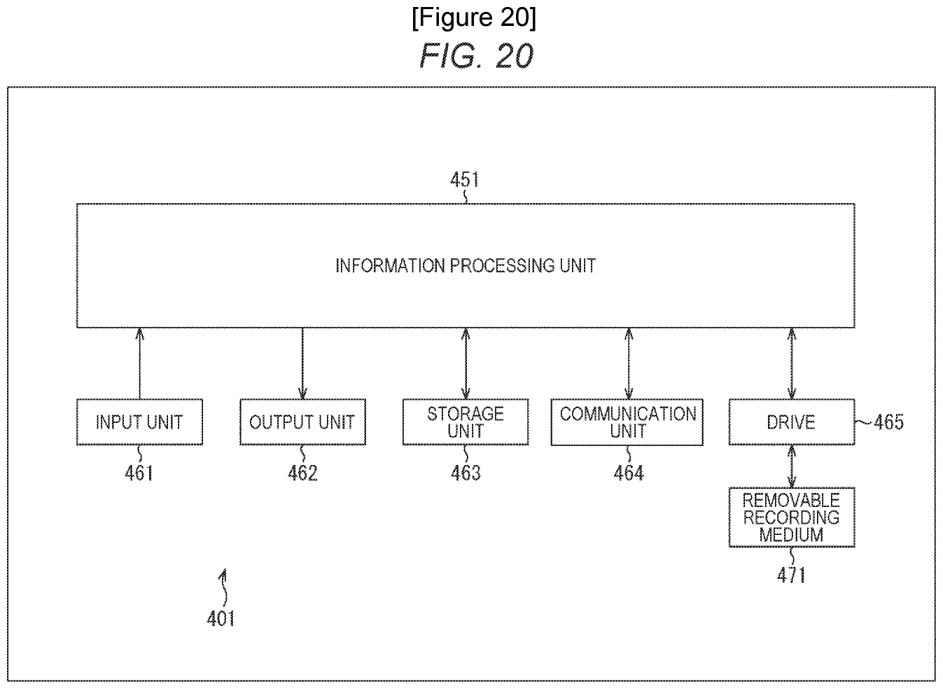

FIG. 20 is a diagram illustrating a main configuration example of the control device 401 which is one embodiment of an information processing device to which the present technology is applied. As illustrated in FIG. 20, the control device 401 includes an information processing unit 451, an input unit 461, an output unit 462, a storage unit 463, a communication unit 464, and a drive 465.

The information processing unit 451 is a computer that includes, for example, a CPU, a ROM, a RAM, and the like, and can implement various functions by executing an application program (software) using the CPU, the ROM, the RAM, and the like. For example, the information processing unit 451 can install and execute an application program (software) that performs processing related to control of image projection. Here, the computer includes a computer incorporated in dedicated hardware, a general-purpose personal computer for example that can execute various functions by installing various programs, and the like.

The input unit 461 includes, for example, input devices such as a keyboard, a mouse, a microphone, a touch panel, and an input terminal, and can supply information input via these input devices to the information processing unit 451.

The output unit 462 includes, for example, output devices such as a display (display unit), a speaker (audio output unit), and an output terminal, and can output the information supplied from the information processing unit 451 via these output devices.

The storage unit 463 includes, for example, a storage medium such as a hard disk, a RAM disk, or a non-volatile memory, and can store the information supplied from the information processing unit 451 in the storage medium. The storage unit 463 can read information stored in the storage medium and supply the information to the information processing unit 451.

The communication unit 464 can include, for example, a network interface, can receive information transmitted from another device, and can supply the received information to the information processing unit 451. The communication unit 464 can transmit the information supplied from the information processing unit 451 to another device.

The drive 465 has an interface of a removable recording medium 471 such as a magnetic disk, an optical disk, a magneto-optical disk, or a semiconductor memory, and can read information recorded on the removable recording medium 471 mounted on itself and supply the information to the information processing unit 451. The drive 465 can record the information supplied from the information processing unit 451 in the writable removable recording medium 471 mounted on itself.

For example, the information processing unit 451 loads and executes an application program stored in the storage unit 463. At that time, the information processing unit 451 can appropriately store data and the like necessary for executing various types of processing. The application program, data, and the like can be provided by being recorded in the removable recording medium 471 as a package medium or the like, for example. In that case, the application program, data, and the like are read by the drive 465 on which the removable recording medium 471 is mounted, and are installed in the storage unit 463 via the information processing unit 451. Furthermore, this application program can also be provided via a wired or wireless transmission medium such as a local area network, the Internet, or digital satellite broadcasting. In this case, the application program, data, and the like are received by the communication unit 464 and installed in the storage unit 463 via the information processing unit 451. Furthermore, the application program, data, and the like can be installed in advance in the ROM or the storage unit 463 in the information processing unit 451.

<Functional Block of Control Device>

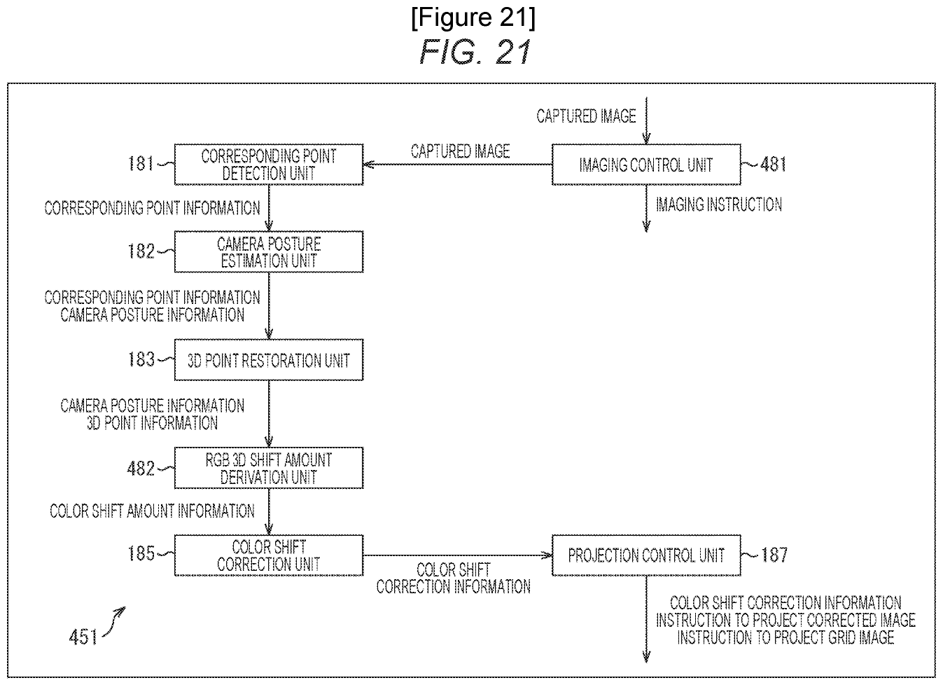

Functions implemented by the information processing unit 451 executing an application program are illustrated in FIG. 21 as functional blocks. As illustrated in FIG. 21, the information processing unit 451 can include, as the functional blocks, the corresponding point detection unit 181, the camera posture estimation unit 182, the 3D point restoration unit 183, the color shift correction unit 185, the projection control unit 187, an imaging control unit 481, and an RGB 3D point shift amount derivation unit 482 by executing the application program.

The imaging control unit 481 supplies an imaging instruction to the camera, causes the camera 403 to capture an image of (the projection image 421 projected on) the screen 120, and acquires the captured image. The imaging control unit 481 supplies the captured image acquired from each camera 403 to the corresponding point detection unit 181. The imaging control unit 481 performs such control processing for each color of projected structured light, and obtains a plurality of captured images captured from different positions for each color of the structured light.

The corresponding point detection unit 181 performs the corresponding point detection for each color of the structured light and generates the corresponding point information. That is, the corresponding point detection unit 181 detects corresponding points in the plurality of captured images obtained by capturing the same projection image from different positions for each color of the projected structured light. The camera posture estimation unit 182 estimates the posture of the camera 403 for each color of the structured light and generates the camera posture information. The 3D point restoration unit 183 restores 3D points for each color of the structured light and generates the 3D point information.

The RGB 3D point shift amount derivation unit 482 derives a shift amount of 3D points between RGB colors on the basis of the camera posture information and the 3D point information supplied from the 3D point restoration unit 183, and generates the color shift amount information. That is, in this case, the RGB 3D point shift amount derivation unit 482 defines the sum of squares of distances between triangulation points for each of R, G, and B as the magnitude of the color shift amount, defines a direction of a vector connecting the respective triangulation points as a direction of the color shift amount, and derives the color shift amount. The RGB 3D point shift amount derivation unit 482 supplies the color shift amount information to the color shift correction unit 185.

The color shift correction unit 185 performs correction to reduce the magnitude of the color shift amount on the basis of the color shift amount information, generates the color shift correction information, and supplies the color shift correction information to the projection control unit 187. That is, the color shift correction unit 185 performs the correction so that the magnitude of the color shift amount becomes sufficiently small.

The projection control unit 187 supplies the color shift correction information to the projector 102. Furthermore, the projection control unit 187 supplies an instruction to project the corrected image to the projector 102 to project the corrected image. Moreover, the projection control unit 187 supplies an instruction to project a grid image to the projector 102 to project the grid image.

<Functional Block of Projector>

The projector 102 in this case has a configuration similar to that in the case of FIG. 5. Functions implemented by the information processing unit 201 executing an application program in this case are illustrated in FIG. 16 as functional blocks. As illustrated in FIG. 16, the information processing unit 201 can include the color shift correction information acquisition unit 232, the structured light generation unit 233, the corrected image generation unit 234, and a grid image generation unit 491 as the functional blocks by executing an application program.

The grid image generation unit 491 generates a grid image, which is an image of a grid pattern for visual check, and supplies the grid image to the corrected image generation unit 234. As in the case of projecting the corrected image, the corrected image generation unit 234 supplies the grid image to the projection unit 202 to project the grid image.

<Camera>

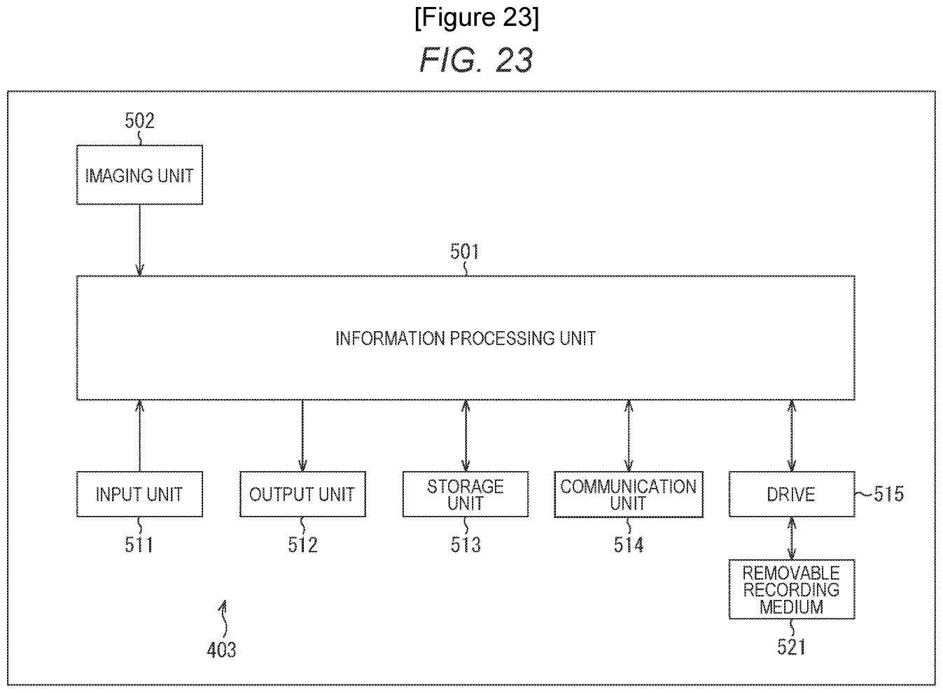

FIG. 23 is a diagram illustrating a main configuration example of the camera 403 which is one embodiment of an information processing device to which the present technology is applied. As illustrated in FIG. 23, the camera 403 includes an information processing unit 501, an imaging unit 502, an input unit 511, an output unit 512, a storage unit 513, a communication unit 514, and a drive 515.

The information processing unit 501 is a computer that includes, for example, a CPU, a ROM, a RAM, and the like, and can implement various functions by executing an application program (software) using the CPU, the ROM, the RAM, and the like. For example, the information processing unit 501 can install and execute an application program (software) that performs processing related to imaging. Here, the computer includes a computer incorporated in dedicated hardware, a general-purpose personal computer for example that can execute various functions by installing various programs, and the like.

The imaging unit 502 includes an optical system, an image sensor, and the like, and can image a subject and generate a captured image. The imaging unit 502 can supply the generated captured image to the information processing unit 501.

The input unit 511 includes, for example, input devices such as a keyboard, a mouse, a microphone, a touch panel, and an input terminal, and can supply information input via these input devices to the information processing unit 501.

The output unit 512 includes, for example, output devices such as a display (display unit), a speaker (audio output unit), and an output terminal, and can output the information supplied from the information processing unit 501 via these output devices.

The storage unit 513 includes, for example, a storage medium such as a hard disk, a RAM disk, or a non-volatile memory, and can store the information supplied from the information processing unit 501 in the storage medium. The storage unit 513 can read information stored in the storage medium and supply the information to the information processing unit 501.

The communication unit 514 includes, for example, a network interface, can receive information transmitted from another device, and can supply the received information to the information processing unit 501. The communication unit 514 can transmit the information supplied from the information processing unit 501 to another device.

The drive 515 has an interface of a removable recording medium 521 such as a magnetic disk, an optical disk, a magneto-optical disk, or a semiconductor memory, and can read information recorded on the removable recording medium 521 mounted on itself and supply the information to the information processing unit 501. The drive 515 can record the information supplied from the information processing unit 501 in the writable removable recording medium 521 mounted on itself.

For example, the information processing unit 501 loads and executes an application program stored in the storage unit 513. At that time, the information processing unit 501 can appropriately store data and the like necessary for executing various types of processing. The application program, data, and the like can be provided by being recorded in the removable recording medium 521 as a package medium or the like, for example. In that case, the application program, data, and the like are read by the drive 515 on which the removable recording medium 521 is mounted, and are installed in the storage unit 513 via the information processing unit 501.

Furthermore, this application program can also be provided via a wired or wireless transmission medium such as a local area network, the Internet, or digital satellite broadcasting. In this case, the application program, data, and the like are received by the communication unit 514 and installed in the storage unit 513 via the information processing unit 501. Furthermore, the application program, data, and the like can be installed in advance in the ROM or the storage unit 513 in the information processing unit 501.

<Functional Block of Camera>

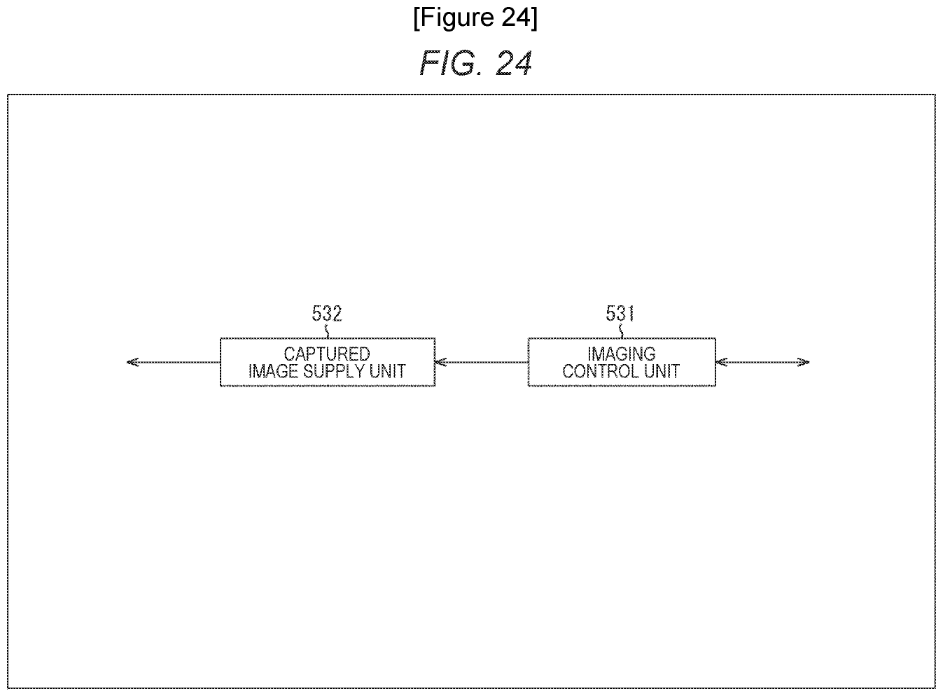

Functions implemented by the information processing unit 501 executing an application program are illustrated in FIG. 24 as functional blocks. As illustrated in FIG. 24, the information processing unit 501 can include an imaging control unit 531 and a captured image supply unit 532 as the functional blocks by executing the application program.

The imaging control unit 531 controls the imaging unit 502 on the basis of an instruction from (the imaging control unit 481 of) the control device 401 to image a subject and generate a captured image. The imaging control unit 531 acquires the captured image and supplies the captured image to the captured image supply unit 532.

The captured image supply unit 532 supplies the captured image supplied from the imaging control unit 531 to (the imaging control unit 481 of) the control device 401 via the communication unit 514.

<Flow of Color Shift Correction Processing>

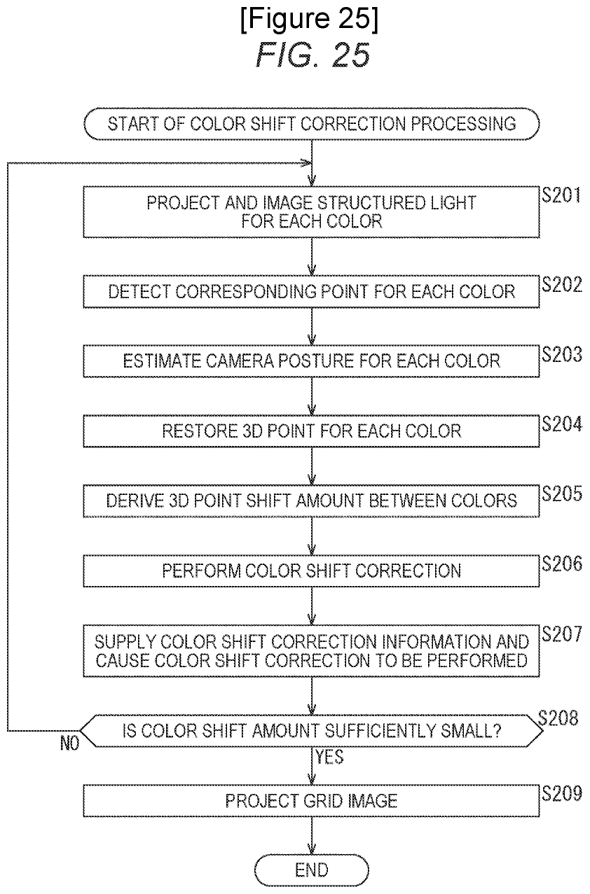

An example of a flow of the color shift correction processing executed by the information processing unit 451 of the control device 401 will be described with reference to a flowchart of FIG. 25.

When the color shift correction processing is started, the projection control unit 187 controls the projector 102 to project structured light in step S201. The imaging control unit 481 controls each camera 403 to capture the projection image 421 of the structured light projected on the screen 120.

This operation is repeated while changing the color of the structured light. That is, this projection and imaging are performed for each color of the structured light.

Next, in step S202, the corresponding point detection unit 181 detects corresponding points on the basis of the plurality of captured images generated as described above. The corresponding point detection unit 181 performs the corresponding point detection for each color of the structured light. That is, the corresponding point detection unit 181 detects corresponding points in a plurality of captured images obtained by imaging the structured light of the same color. The method of detecting the corresponding point is similar to that in the case of the first embodiment. The corresponding point detection unit 181 performs this processing for each color of the structured light.

In step S203, the camera posture estimation unit 182 estimates each posture (position and posture) of the camera 403-1 and the camera 403-2. The camera posture estimation unit 182 estimates the posture of each camera 403 for each color of the structured light. The method of posture estimation is similar to that in the case of the first embodiment.

In step S204, the 3D point restoration unit 183 restores the 3D point 341, which is the 3D projection position of each pixel, on the basis of the position and posture of each camera estimated as described above. The 3D point restoration unit 183 performs this processing for each color of the structured light. A method of restoring the 3D point is similar to that in the case of the first embodiment.

In step S205, the RGB 3D point shift amount derivation unit 482 derives a shift amount (size or direction) of 3D points between colors as a color shift amount.

In step S206, the color shift correction unit 185 performs the color shift correction so as to reduce the magnitude of the color shift amount (that is, a shift amount between colors of the structured light) derived in step S205. This correction method is similar to that in the case of the first embodiment. A correction amount at that time may be a fixed value or may be adaptively variable. For example, the correction may be performed with the correction amount corresponding to the magnitude of the color shift amount. Furthermore, in a case where a surveying error between two light beams among the RGB light beams is small (for example, they intersect at approximately one point) but a surveying error with a remaining light beam is large, a method of correcting only a color component corresponding to the light beam can also be applied.

In step S207, the projection control unit 187 supplies the color shift correction information to the projector and causes the projector 102 to perform the color shift correction.

In step S208, the color shift correction unit 185 determines whether or not (the magnitude of) the color shift amount is sufficiently small. In a case where it is determined that the color shift amount is large, the processing returns to step S201. Then, in a case where it is determined in step S208 that the color shift amount is sufficiently small, the processing proceeds to step S209.

That is, each process of steps S201 to S208 is repeatedly executed until it is determined in step S208 that the color shift amount is sufficiently small (for example, RGB light beams are close to each other in the three-dimensional space (ideally intersect at one point)).

In step S209, the projection control unit 187 instructs the projector 102 to project the grid image, and causes the projector 102 to project the grid image for the user to visually check the color shift.

When the process of step S209 ends, the color shift correction processing ends.

By performing the color shift correction processing in this manner, the control device 401 can perform three-dimensional color shift correction. Therefore, the color shift can be corrected more easily.

<Flow of Color Shift Correction Processing>

At the time of performing the color shift correction, one of RGB colors may be used as a reference (target color), and the correction may be performed for other colors in such a manner that the shift amount between the other colors and the target color is reduced.

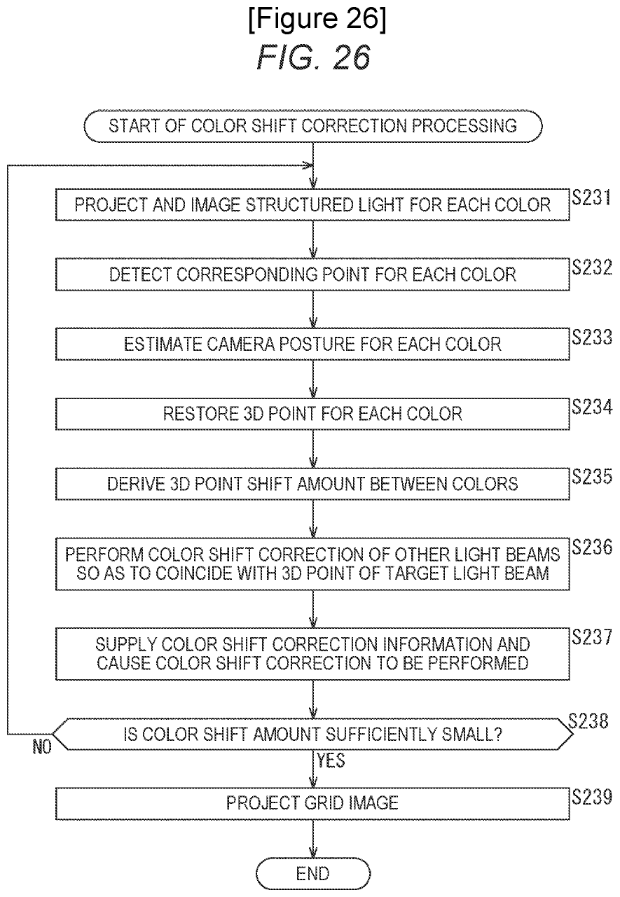

Also in this case, the configuration of each device is similar to that in the case of the projection imaging system 400 described above. An example of a flow of the color shift correction processing executed by the information processing unit 451 of the control device 401 in this case will be described with reference to a flowchart of FIG. 26.

When the color shift correction processing is started, each process of steps S231 to S235 is executed similarly to each process of steps S201 to S205 of the flowchart of FIG. 25.

In step S236, the color shift correction unit 185 corrects the color shift so that the 3D points of other light beams coincide with (approaches) the 3D point of a target light beam (one of RGB). The method of correction at that time is similar to that in the case of step S206 in the flowchart of FIG. 25.

Each process of steps S237 to S239 is executed similarly to each process of steps S207 to S209 of the flowchart of FIG. 25. When the process of step S239 ends, the color shift correction processing ends.

By performing the color shift correction processing in this manner, the control device 401 can perform three-dimensional color shift correction. Therefore, the color shift can be corrected more easily.

<Color Shift Correction Using White Color>

The color of the structured light may include not only a color projected using one optical device (panel or the like) but also a color projected using a plurality of optical devices (panel or the like). For example, the projector 102 may project white (W) structured light using all the optical devices (panels and the like) and perform the color shift correction using the captured image.

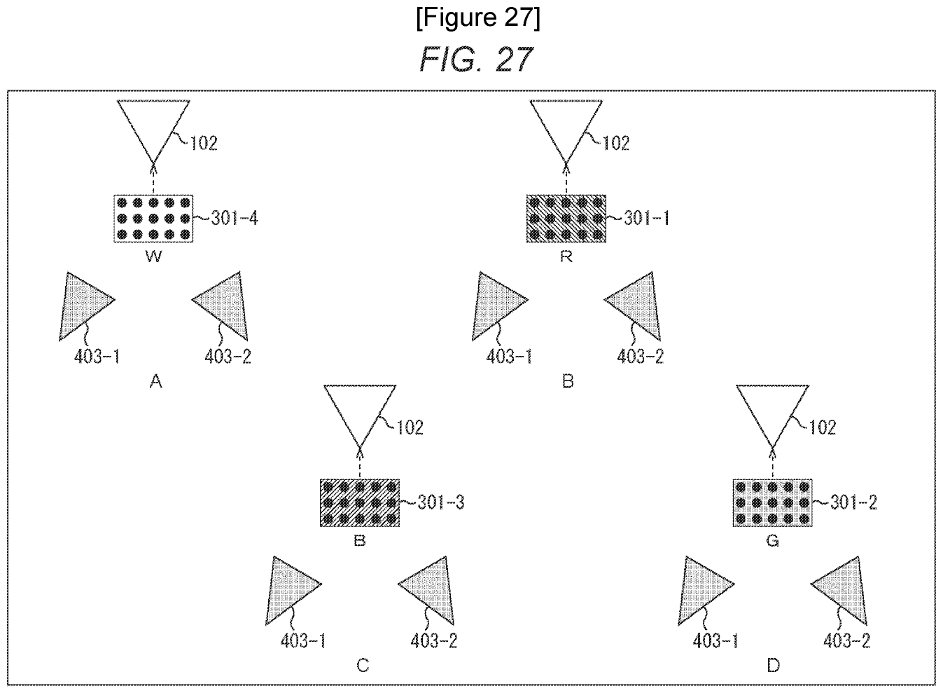

For example, in the first time, as illustrated in A of FIG. 27, the projector 102 projects structured light 301-4 (W), and the camera 403-1 and the camera 403-2 capture projection images from the left and right as illustrated in the drawing. In the second time, as illustrated in B of FIG. 27, the projector 102 projects the structured light 301-1 (R), and the camera 403-1 and the camera 403-2 capture projection images from the left and right as illustrated in the drawing. In the third time, as illustrated in C of FIG. 27, the projector 102 projects the structured light 301-3 (B), and the camera 403-1 and the camera 403-2 capture projection images from the left and right as illustrated in the drawing. In the fourth time, as illustrated in D of FIG. 27, the projector 102 projects the structured light 301-2 (G), and the camera 403-1 and the camera 403-2 capture projection images from the left and right as illustrated in the drawing.

In this manner, a plurality of captured images is generated at each time (that is, for each color of the structured light), and corresponding points are detected using the plurality of captured images. Then, in a case where the color shift correction is performed, the correction is performed so that 3D points of other colors approach the 3D points corresponding to the white (W) structural image.

<Functional Block of Control Device>

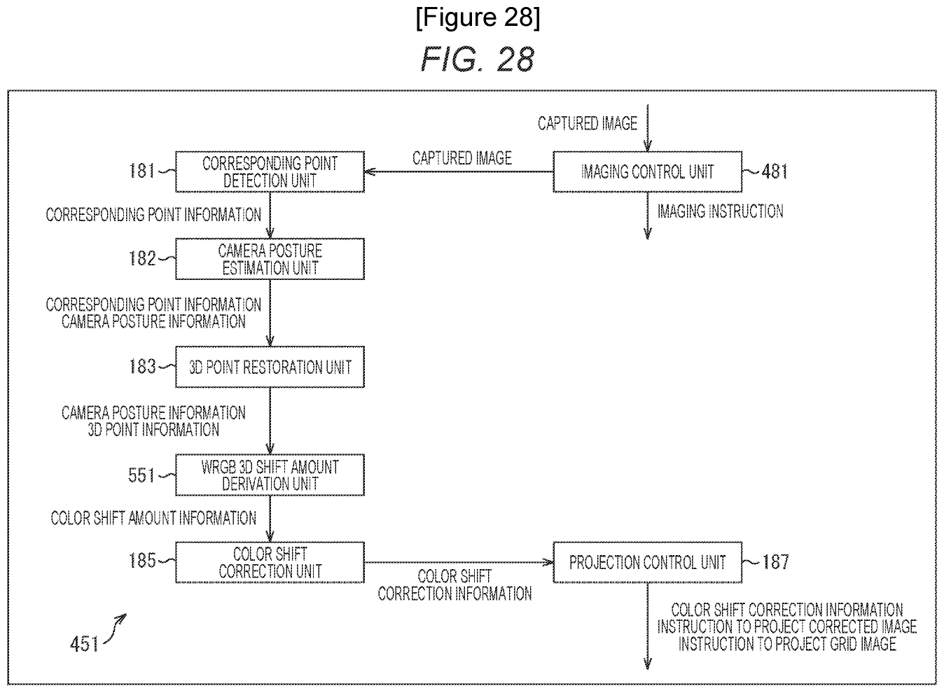

Functions implemented by the information processing unit 451 executing an application program in this case are illustrated in FIG. 28 as functional blocks. As illustrated in FIG. 28, the information processing unit 451 can include, as the functional blocks, the corresponding point detection unit 181, the camera posture estimation unit 182, the 3D point restoration unit 183, the color shift correction unit 185, the projection control unit 187, an imaging control unit 481, and a WRGB 3D point shift amount derivation unit 551 by executing the application program.

As described above, the imaging control unit 481 acquires the captured image of the projection image for each of the four colors of structured light of W, R, G, and B.

The corresponding point detection unit 181 performs the corresponding point detection for each color of the structured light and generates the corresponding point information. That is, the corresponding point detection unit 181 detects corresponding points in the plurality of captured images obtained by capturing the same projection image from different positions for each color of the projected structured light. The camera posture estimation unit 182 estimates the posture of the camera 403 for each color of the structured light and generates the camera posture information. The 3D point restoration unit 183 restores 3D points for each color of the structured light and generates the 3D point information.

The WRGB 3D point shift amount derivation unit 551 derives a shift amount of 3D points between W and RGB on the basis of the camera posture information and the 3D point information supplied from the 3D point restoration unit 183, and generates the color shift amount information. That is, in this case, the WRGB 3D point shift amount derivation unit 551 defines the sum of squares of distances between triangulation points for each of W, R, G, and B as the magnitude of the color shift amount, defines a direction of a vector connecting the respective triangulation points as a direction of the color shift amount, and derives the color shift amount.

The WRGB 3D point shift amount derivation unit 551 supplies the color shift amount information to the color shift correction unit 185.

On the basis of the color shift amount information, the color shift correction unit 185 performs the color shift correction so as to bring the 3D points of RGB close to the 3D point of W (that is, in such a manner that the magnitude of the color shift amount between W and each of RGB is reduced), generates the color shift correction information, and supplies the color shift correction information to the projection control unit 187.

<Flow of Color Shift Correction Processing>

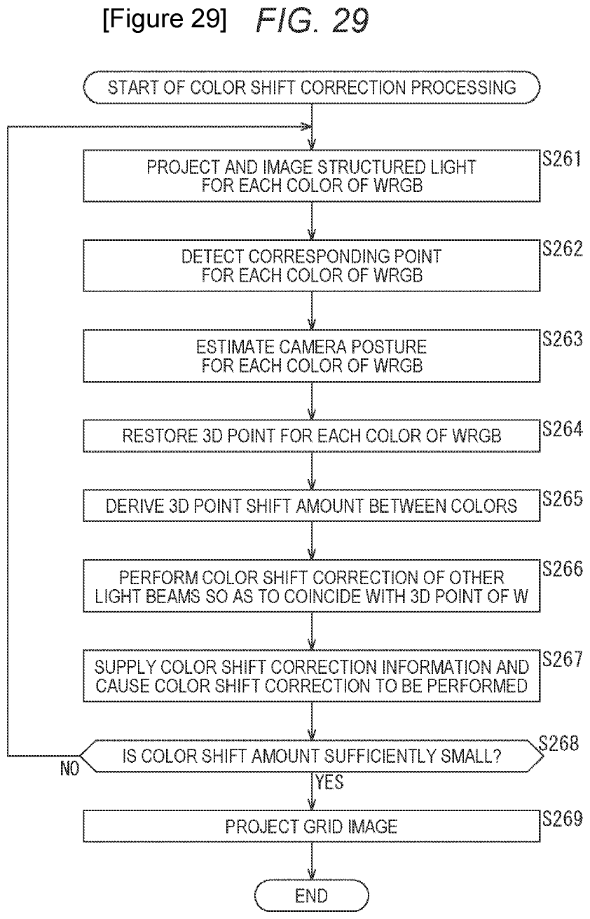

An example of a flow of the color shift correction processing executed by the information processing unit 451 of the control device 401 in this case will be described with reference to a flowchart of FIG. 29.

When the color shift correction processing is started, each process of steps S261 to S265 is executed similarly to each process of steps S231 to S235 of the flowchart of FIG. 26. However, in the case of the flowchart of FIG. 26, the processes of these steps are performed for each of the structured light of three colors of RGB, whereas in the case of the flowchart of FIG. 29, the processes of these steps are performed for each of the structured light of four colors of WRGB.

In step S266, the color shift correction unit 185 corrects the color shift so that the 3D points of other (RGB) light beams coincide with (approaches) the 3D point of white (W). The method of correction at that time is similar to that in the case of step S206 in the flowchart of FIG. 25.

Each process of steps S267 to S269 is executed similarly to each process of steps S237 to S239 of the flowchart of FIG. 26. When the process of step S269 ends, the color shift correction processing ends.

By performing the color shift correction processing in this manner, the control device 401 can perform three-dimensional color shift correction. Therefore, the color shift can be corrected more easily.

### 4. THIRD EMBODIMENT

<Projection Imaging System>

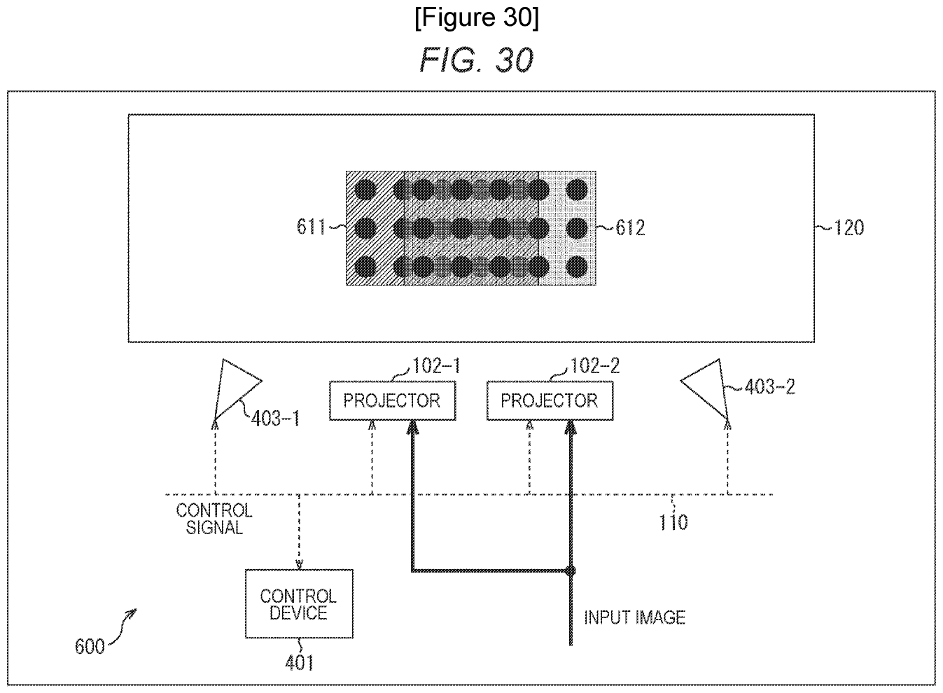

Instead of performing the color shift correction, geometric correction that also compensates for the color shift correction may be performed. FIG. 30 is a block diagram illustrating a main configuration example of a projection imaging system which is one embodiment of an information processing system to which the present technology in this case is applied. Similarly to the projection imaging system 100 in FIG. 2, a projection imaging system 600 illustrated in FIG. 30 is a system that projects an image on the screen 120 or images the screen 120, and is a system that can perform the color shift correction.

The projection imaging system 400 includes the projector 102-1, the projector 102-2, the control device 401, a camera 403-1, and a camera 403-2. The projector 102-1, the projector 102-2, the control device 401, the camera 403-1, and the camera 403-2 are communicably connected to each other via the communication path 110. As in the case of FIG. 2, the communication path 110 is arbitrary, and may be either wired or wireless. For example, the projector 102-1, the projector 102-2, the control device 401, the camera 403-1, and the camera 403-2 can exchange control signals, image data, and the like via the communication path 110.

The projector 102-1 and the projector 102-2 can project an input image on the screen 120, for example, in accordance with control of the control device 401. At that time, the projector 102-1 and the projector 102-2 can project images in cooperation with each other, as in the case of the projection imaging system 100. For example, in the case of the example of FIG. 30, a projection image 611 and a projection image 612 of structured light of different colors are projected on the screen 120 so as to be superimposed on each other. The projection image 611 is a projection image projected by the projector 102-1. The projection image 612 is a projection image projected by the projector 102-2.

The camera 403-1 and the camera 403-2 capture the projection image 611 and the projection image 612 projected onto the screen 120 from different positions.

The control device 401 controls the projector 102-1 and the projector 102-2 to change the combination of colors of the structured light and project the structured light, and controls the camera 403-1 and the camera 403-2 to capture an image of the projection image. Such projection and imaging are repeated while changing the combination of colors of structured light.

Although FIG. 30 illustrates two cameras 403, the number of cameras 403 that images the screen 120 may be any number as long as it is two or more. However, the positions (and postures) of the cameras 403 are different from each other. Furthermore, although two projectors 102 are illustrated in FIG. 30, the number of projectors 102 that project images may be any number as long as it is two or more.

In such a projection imaging system 600, the control device 401 can correct the three-dimensional color shift generated in the projector 102 as in the case of the portable terminal device 101 of the projection imaging system 100.

However, in the case of the projection imaging system 600, the corresponding point detection is performed for each combination of colors of the structured light projected by each projector 102.

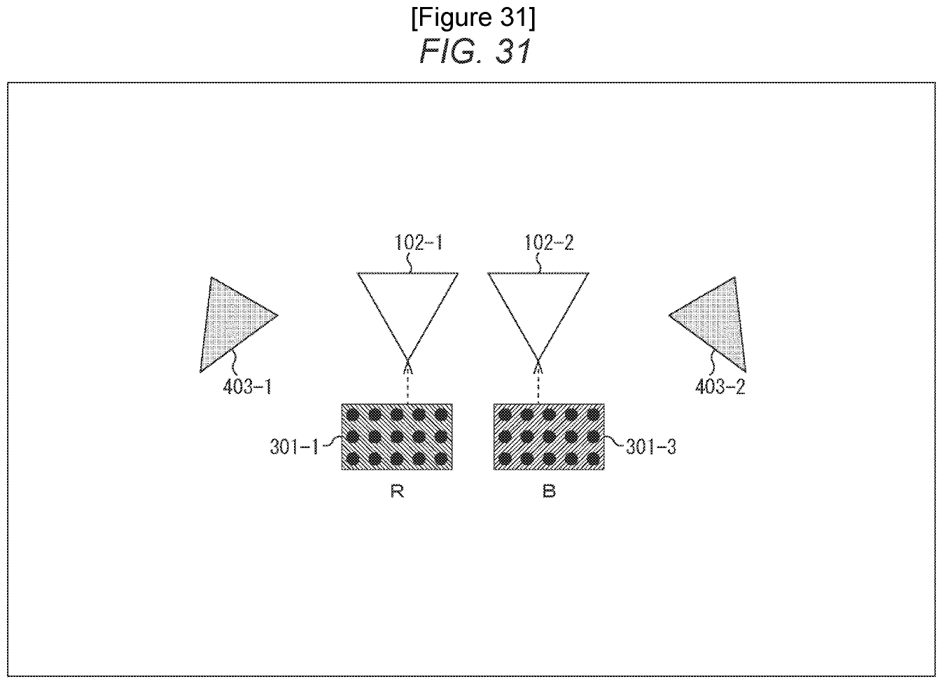

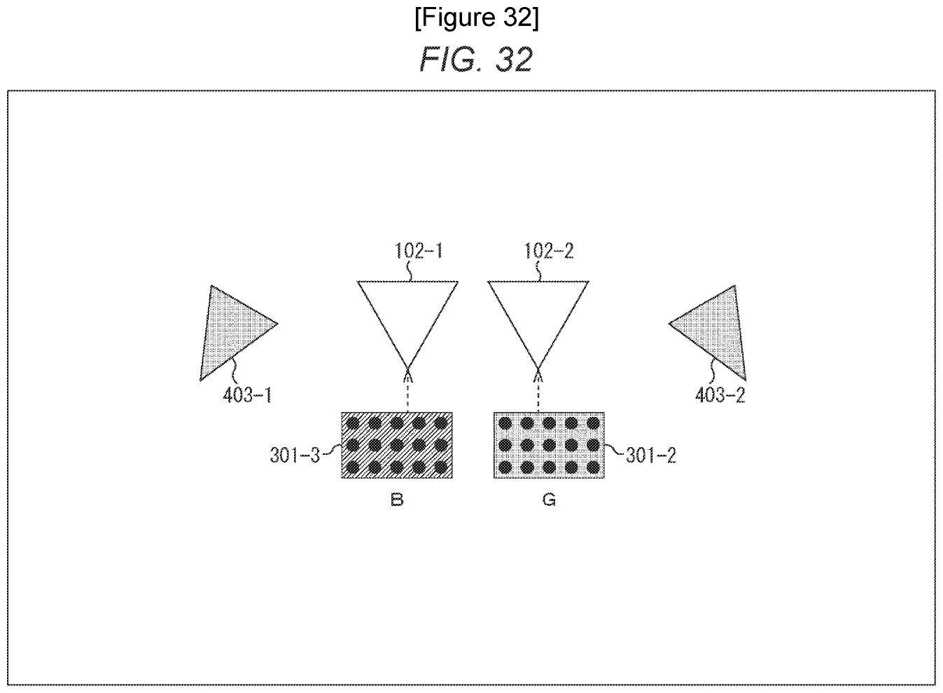

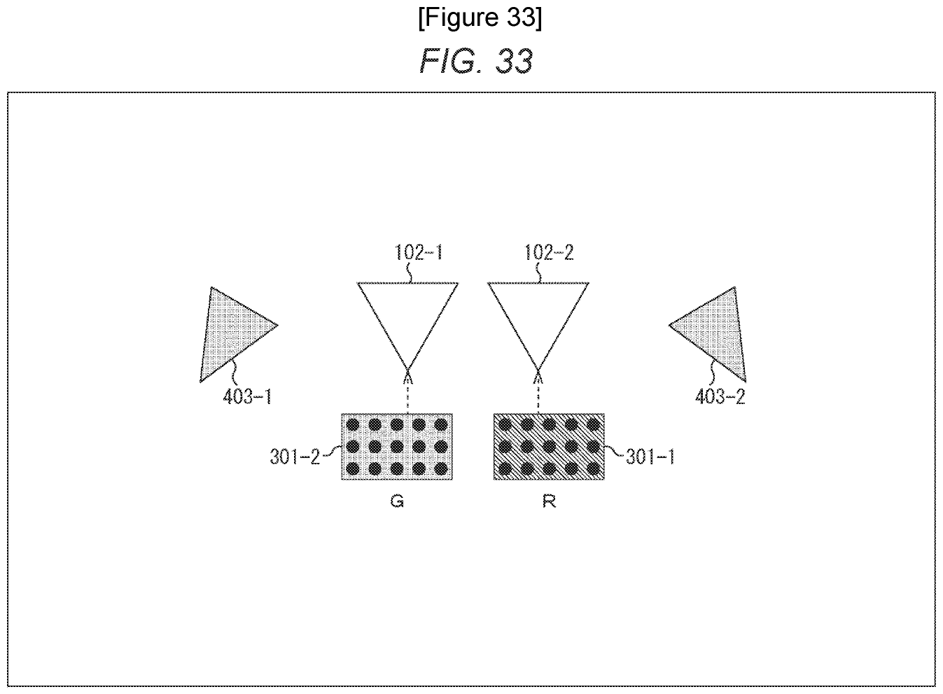

For example, in the first time, as illustrated in FIG. 31, the projector 102-1 projects the structured light 301-1 (R), the projector 102-2 projects the structured light 301-3 (B), and the camera 403-1 and the camera 403-2 capture projection images from the left and right as illustrated in the drawing. In the second time, as illustrated in FIG. 32, the projector 102-1 projects the structured light 301-3 (B), the projector 102-2 projects the structured light 301-2 (G), and the camera 403-1 and the camera 403-2 capture projection images from the left and right as illustrated in the drawing. In the third time, as illustrated in FIG. 33, the projector 102-1 projects the structured light 301-2 (G), the projector 102-2 projects the structured light 301-1 (R), and the camera 403-1 and the camera 403-2 capture projection images from the left and right as illustrated in the drawing.

In this manner, a plurality of captured images is generated at each time (that is, for each combination of colors of structured light), and corresponding points are detected using the plurality of captured images.

<Functional Block of Control Device>

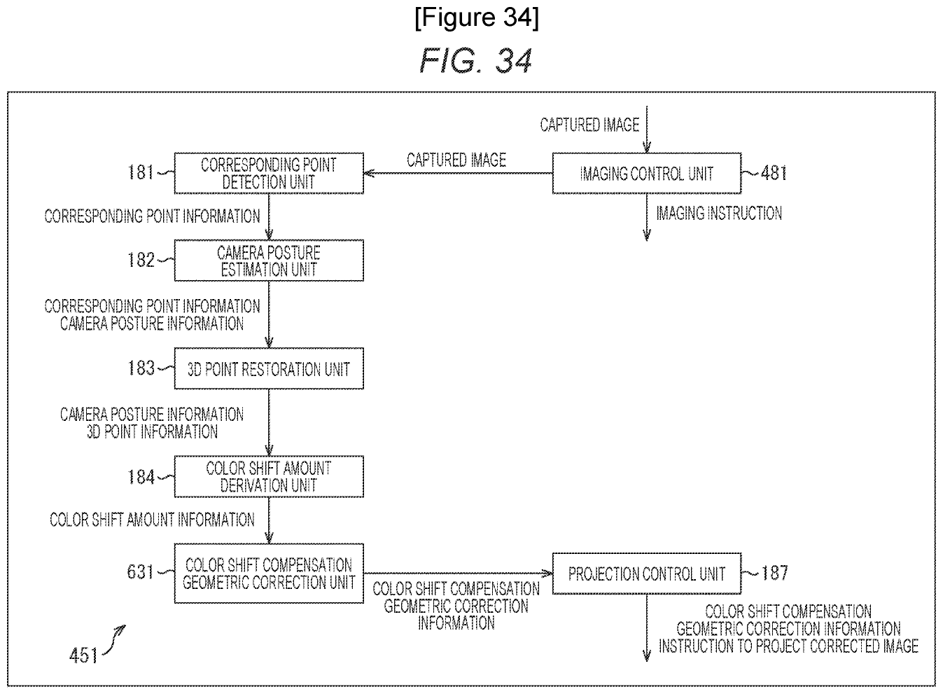

Functions implemented by the information processing unit 451 executing an application program are illustrated in FIG. 34 as functional blocks. As illustrated in FIG. 34, the information processing unit 451 can include, as the functional blocks, the corresponding point detection unit 181, the camera posture estimation unit 182, the 3D point restoration unit 183, the color shift amount derivation unit 184, the projection control unit 187, the imaging control unit 481, and a color shift compensation geometric correction unit 631 by executing the application program.

The imaging control unit 481 supplies an imaging instruction to the camera 403, causes the screen 120 (the projection image 611 and the projection image 612 projected on the screen) to be imaged, and acquires the captured image. The imaging control unit 481 supplies the captured image acquired from each camera 403 to the corresponding point detection unit 181. The imaging control unit 481 performs such control processing for each combination of colors of the projected structured light, and obtains a plurality of captured images captured from different positions for each combination of colors of the structured light.

The corresponding point detection unit 181 performs the corresponding point detection for each combination of colors of structured light and generates the corresponding point information. As in the case of the projection imaging system 100, the corresponding point detection unit 181 derives captured images of the projection images of the respective colors for the respective projection units by separating the projection images in the plurality of captured images of the projection images of different combinations of colors. Then, the corresponding point detection unit 181 detects the corresponding point using the captured image for each combination of colors of the structured light. That is, the corresponding point detection unit separates the projection images in the captured images of the projection images of different colors projected simultaneously from the plurality of projectors 102, derives the captured images of the projection images of different colors, and detects the corresponding point for each color.

Similarly, the camera posture estimation unit 182, the 3D point restoration unit 183, and the color shift amount derivation unit 184 perform respective processes for each combination of colors of structured light.

The color shift compensation geometric correction unit 631 performs the geometric correction that compensates for the color shift correction that reduces (the magnitude of) the color shift amount derived by the color shift amount derivation unit 184. That is, by performing this geometric correction, it is compensated that the color shift amount becomes sufficiently small. The color shift compensation geometric correction unit 631 supplies color shift compensation geometric correction information, which is control information for the geometric correction, to the projection control unit 187.

The projection control unit 187 supplies the color shift compensation geometric correction information to each projector 102. Furthermore, the projection control unit 187 supplies an instruction to project the corrected image to each projector 102 to project the corrected image.

<Functional Block of Projector>

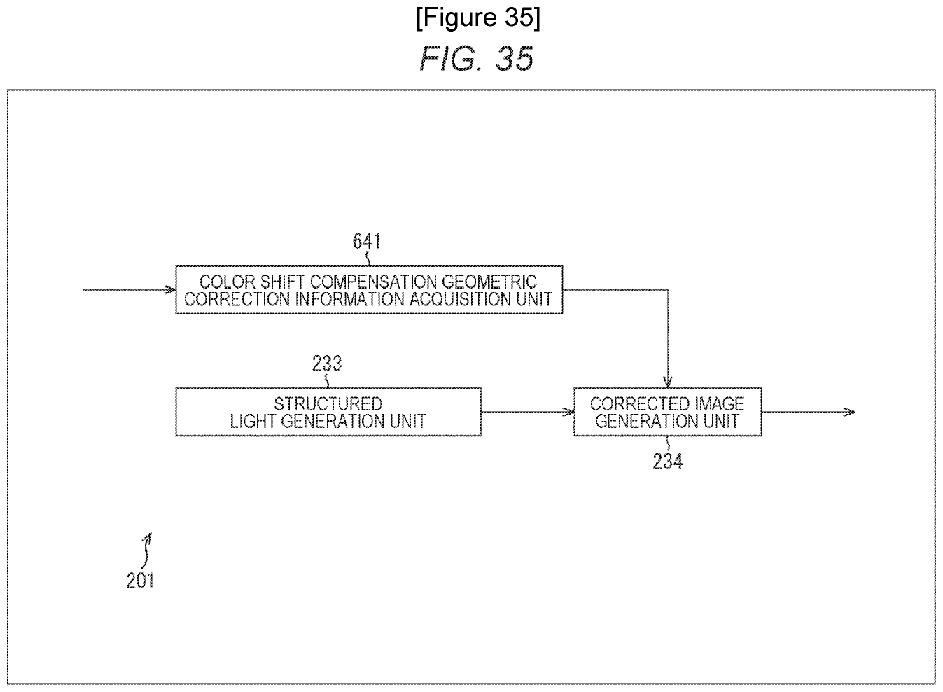

Functions implemented by the information processing unit 201 executing an application program in this case are illustrated in FIG. 35 as functional blocks. As illustrated in FIG. 35, the information processing unit 201 can include a color shift compensation geometric correction information acquisition unit 641, the structured light generation unit 233, and the corrected image generation unit 234 as the functional blocks by executing the application program.

The color shift compensation geometric correction information acquisition unit 641 acquires the color shift compensation geometric correction information supplied from the control device 401 and supplies the same to the corrected image generation unit 234.

The corrected image generation unit 234 corrects the structured light on the basis of the control of the control device 401 and generates a corrected image. For example, the corrected image generation unit 234 geometrically corrects the structured light on the basis of the color shift compensation geometric correction information, and generates a corrected image in which (the magnitude of) the color shift amount is reduced. The corrected image generation unit 234 supplies the corrected image to the projection unit 202, so that the corrected image is projected.

As described above, since the control device 401 performs the geometric correction so as to correct the color shift on the basis of the 3D projection position, it is possible to correct the three-dimensional color shift. Furthermore, the projector 102 can project a corrected image subjected to the geometric correction for reducing the color shift amount. Therefore, the projection imaging system 600 can correct the color shift more easily.

<Flow of Color Shift Correction Processing>

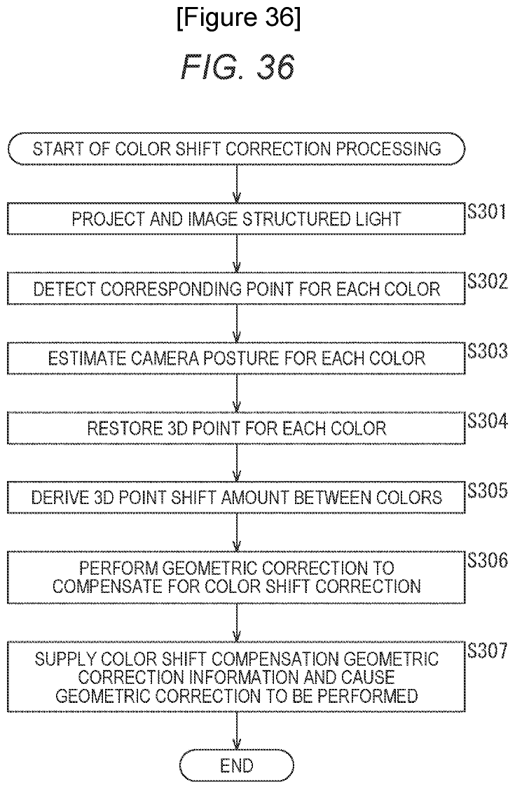

An example of a flow of the color shift correction processing executed by the information processing unit 451 of the control device 401 in this case will be described with reference to a flowchart of FIG. 36.

When the color shift correction processing is started, in step S301, the projection control unit 187 controls each projector 102 to project structured light of different colors. The imaging control unit 481 controls each camera 403 to capture the projection image 611 and the projection image 612 of structured light of different colors projected on the screen 120.

This operation is repeated while changing the combination of colors of the structured light. That is, this projection and imaging are performed for each combination of colors of structured light.

Next, in step S302, the corresponding point detection unit 181 detects corresponding points on the basis of the plurality of captured images generated as described above. The corresponding point detection unit 181 performs the corresponding point detection for each combination of colors of the structured light. The method of detecting the corresponding point is similar to that in the case of the first embodiment.

In step S303, the camera posture estimation unit 182 estimates each posture (position and posture) of the camera 403-1 and the camera 403-2. The camera posture estimation unit 182 estimates the posture of each camera 403 for each combination of colors of structured light. The method of posture estimation is similar to that in the case of the first embodiment.

In step S304, the 3D point restoration unit 183 restores the 3D point 341, which is the 3D projection position of each pixel, on the basis of the position and posture of each camera estimated as described above. The 3D point restoration unit 183 performs this processing for each combination of colors of the structured light. A method of restoring the 3D point is similar to that in the case of the first embodiment.

In step S305, the color shift amount derivation unit 184 derives a shift amount (size or direction) of 3D points between colors as a color shift amount. That is, in this case, the color shift amount derivation unit 184 defines the sum of squares of the distances between triangulation points for each color combination as the magnitude of the color shift amount, defines the direction of the vector connecting the respective triangulation points as the direction of the color shift amount, and derives the color shift amount.

In step S306, the color shift compensation geometric correction unit 631 performs geometric correction to compensate for the color shift correction that reduces the color shift amount (that is, a shift amount between colors of the structured light) derived in step S305. This correction method is similar to that in the case of the first embodiment. A correction amount at that time may be a fixed value or may be adaptively variable. For example, the correction may be performed with the correction amount corresponding to the magnitude of the color shift amount. Furthermore, in a case where a surveying error between two light beams among the RGB light beams is small (for example, they intersect at approximately one point) but a surveying error with a remaining light beam is large, a method of correcting only a color component corresponding to the light beam can also be applied.

In step S307, the projection control unit 187 supplies the color shift compensation geometric correction information to the projector, and causes the projector 102 to perform geometric correction in consideration of the color shift correction.

When the process of step S307 ends, the color shift correction processing ends.

By performing the color shift correction processing in this manner, the control device 401 can perform three-dimensional color shift correction. Therefore, the color shift can be corrected more easily.

### 5. APPENDIX

<Hardware>

The above-described series of processes can be executed by software (application program) or can be executed by hardware.

<Applicable Target of Present Technology>

Furthermore, the present technology can be implemented as any component mounted on an arbitrary device or a device constituting a system, for example, a processor as system large scale integration (LSI) or the like (for example, a video processor), a module using a plurality of processors or the like (for example, a video module), a unit using a plurality of modules or the like (for example, a video unit), a set obtained by further adding other functions to the unit (for example, a video set), and the like (that is, a configuration of a part of the device).

Moreover, the present technology can also be applied to a network system including a plurality of devices. For example, application to a cloud service that provides a service related to an image (moving image) is possible for any terminal such as a computer, an audio visual (AV) device, a portable information processing terminal, an Internet of Things (IoT) device, and the like.

Note that the system, device, processing unit, and the like to which the present technology is applied can be used in any fields, for example, traffic, medical care, crime prevention, agriculture, livestock industry, mining, beauty, factory, household appliance, weather, nature monitoring, and the like. Furthermore, its use is arbitrary.

For example, the present technology can be applied to systems and devices used for providing contents for appreciation and the like. Furthermore, for example, the present technology can also be applied to systems and devices used for traffic, such as traffic condition management and automated driving control. Moreover, for example, the present technology can also be applied to systems and devices used for security. Furthermore, for example, the present technology can be applied to systems and devices used for automatic control of a machine or the like. Moreover, for example, the present technology can also be applied to systems and devices provided for use in agriculture and livestock industry. Furthermore, the present technology can also be applied to systems and devices that monitor, for example, the status of nature such as a volcano, a forest, and the ocean, wildlife, and the like. Moreover, for example, the present technology can also be applied to systems and devices used for sports.

<Others>

The embodiments of the present technology are not limited to the above-described embodiments, and various modifications are possible without departing from the gist of the present technology.

For example, the present technology can be implemented as any component that constitutes a device or a system, for example, a processor as system large scale integration (LSI) or the like (for example, a video processor), a module using a plurality of processors or the like (for example, a video module), a unit using a plurality of modules or the like (for example, a video unit), a set obtained by further adding other functions to the unit (for example, a video set), and the like (that is, a configuration of a part of the device).

Note that in the present description, the system means a set of a plurality of components (devices, modules (parts), and the like), and it does not matter whether or not all the components are in the same housing. Therefore, a plurality of devices housed in separate housings and connected via a network, and one device in which a plurality of modules is housed in one housing are all systems.

Further, for example, a configuration described as one device (or processing section) may be divided and configured as a plurality of devices (or processing sections). Conversely, configurations described above as a plurality of devices (or processing sections) may be combined and configured as one device (or processing section). Furthermore, a configuration other than those described above may of course be added to the configuration of each device (or each processing unit). Moreover, if the configuration and operation of the entire system are substantially the same, a part of the configuration of a certain device (or processing unit) may be included in the configuration of another device (or another processing unit).

Furthermore, for example, the present technology can take a cloud computing configuration in which one function is processed in a shared and collaborative manner by a plurality of devices via a network.

Furthermore, for example, the above-described program can be executed by an arbitrary device. In that case, it is sufficient if the device has necessary functions (functional blocks and the like) and can acquire necessary information.

Furthermore, for example, respective steps described in the above-described flowcharts can be executed by one device or can be executed in a shared manner by a plurality of devices. Moreover, in a case where a plurality of processes is included in one step, the plurality of processes included in the one step can be executed in a shared manner by a plurality of devices in addition to being executed by one device. In other words, a plurality of processes included in one step can be executed as processes of a plurality of steps. Conversely, a process described as a plurality of steps can be collectively executed as one step.

Note that the program executed by the computer may be configured so that the processes in the steps for describing the program are executed in chronological order according to the order described in the present description, or may be executed in parallel or individually at a necessary timing such as when a call is made. That is, as long as no contradiction occurs, the processes in the respective steps may be executed in an order different from the above-described orders. Moreover, the processes in steps for describing this program may be executed in parallel with processes in another program, or may be executed in combination with processes in another program.

Note that the plurality of present technologies which has been described in the present description can each be implemented independently as a single unit as long as no contradiction occurs. Of course, any plurality of the present technologies can also be used and implemented in combination. For example, part or all of the present technologies described in any of the embodiments can be implemented in combination with part or all of the present technologies described in other embodiments. Furthermore, part or all of any of the above-described present technologies can be implemented by using together with another technology that is not described above.

Note that the effects described in the present description are merely examples and are not limited, and other effects may be provided.

Note that the present technology can have configurations as follows.
(1) An information processing device, including
a color shift correction unit that corrects a color shift on the basis of a three-dimensional (3D) projection position of each of optical devices of a projection unit that projects red, green, and blue (RGB) light using the optical devices different from each other.
(2) The information processing device according to (1), further including
a color shift amount derivation unit that derives a color shift amount indicating magnitude and a direction of the color shift, in which
the color shift correction unit performs correction in such a manner that the color shift amount derived by the color shift amount derivation unit is reduced.
(3) The information processing device according to (2), further including
a restoration unit that restores the 3D projection position, in which
the color shift correction unit restores the 3D projection position restored by the restoration unit.
(4) The information processing device according to (3), further including
a posture estimation unit that estimates postures of cameras on the basis of a plurality of captured images obtained by capturing projection images by the cameras at different positions, in which
the restoration unit restores the 3D projection position on the basis of the posture of the camera estimated by the posture estimation unit.
(5) The information processing device according to (4), in which
the posture estimation unit estimates a posture of the camera by using the corresponding points detected by the corresponding point detection unit.
(6) The information processing device according to (5), in which
the corresponding point detection unit detects the corresponding points in the plurality of captured images obtained by capturing projection images of respective colors from different positions.
(7) The information processing device according to (6), in which
the corresponding point detection unit separates the projection images in the captured images of projection images of different colors projected simultaneously from a plurality of projection units, and derives captured images of projection images of different colors.
(8) The information processing device according to (7), in which
the corresponding point detection unit derives captured images of the projection images of the respective colors for the respective projection units by separating the projection images in the plurality of captured images of the projection images of different combinations of colors.
(9) The information processing device according to any one of (1) to (8), in which
the color shift correction unit performs geometric correction to correct the color shift.
(10) The information processing device according to any one of (5) to (9), in which
the corresponding point detection unit detects the corresponding points in the plurality of captured images obtained by capturing a same projection image from different positions for each color.
(11) The information processing device according to (10), in which
the color shift correction unit corrects the color shift to be sufficiently small.
(12) The information processing device according to (10) or (11), in which
the color shift correction unit performs correction in such a manner that a color shift from a predetermined target color becomes sufficiently small.
(13) The information processing device according to (12), in which
the target color is white.
(14) The information processing device according to any one of (10) to (13), in which
the corresponding point detection unit separates the projection images in the captured images of projection images of different colors projected simultaneously from a plurality of projection units, derives captured images of projection images of different colors, and detects the corresponding points for each color.
(15) The information processing device according to (14), in which
the color shift correction unit performs geometric correction in such a manner that the color shift amount derived by the color shift amount derivation unit is reduced.
(16) The information processing device according to any one of (1) to (15), further including
a projection control unit that projects a corrected image reflecting the correction of the color shift by the color shift correction unit.
(17) The information processing device according to (16), in which
the projection control unit further projects a grid image.
(18) The information processing device according to any one of (1) to (17), further including
an imaging unit that captures a projection image projected by the projection unit and generates a captured image of the projection image.
(19) The information processing device according to any one of (1) to (18), further including
the projection unit.
(20) An information processing method, including
correcting a color shift on the basis of a three-dimensional (3D) projection position of each of optical devices of a projection unit that projects red, green, and blue (RGB) light using the optical devices different from each other.

### REFERENCE SIGNS LIST

100 Projection imaging system
101 Portable terminal device
102 Projector
151 Information processing unit
152 Imaging unit
181 Corresponding point detection unit
182 Camera posture estimation unit
183 3D point restoration unit
184 Color shift amount derivation unit
185 Color shift correction unit
186 Geometric correction unit
187 Projection control unit
201 Information processing unit
202 Projection unit
231 Geometric correction information acquisition unit
232 Color shift correction information acquisition unit
233 Structured light generation unit
234 Corrected image generation unit
400 Projection imaging system
401 Control device
403 Camera
451 Information processing unit
481 Imaging control unit
482 RGB 3D point shift amount derivation unit
491 Grid image generation unit
501 Information processing unit
502 Imaging unit
531 Imaging control unit
532 Captured image supply unit
551 WRGB 3D point shift amount derivation unit
600 Projection imaging system
631 Color shift compensation geometric correction unit
641 Color shift compensation geometric correction information acquisition unit

1. An information processing device, comprising
a color shift correction unit that corrects a color shift on a basis of a three-dimensional (3D) projection position of each of optical devices of a projection unit that projects red, green, and blue (RGB) light using the optical devices different from each other.

2. The information processing device according to claim 1, further comprising
a color shift amount derivation unit that derives a color shift amount indicating magnitude and a direction of the color shift, wherein
the color shift correction unit performs correction in such a manner that the color shift amount derived by the color shift amount derivation unit is reduced.

3. The information processing device according to claim 2, further comprising
a restoration unit that restores the 3D projection position, wherein
the color shift correction unit restores the 3D projection position restored by the restoration unit.

4. The information processing device according to claim 3, further comprising
a posture estimation unit that estimates postures of cameras on a basis of a plurality of captured images obtained by capturing projection images by the cameras at different positions, wherein
the restoration unit restores the 3D projection position on a basis of the posture of the camera estimated by the posture estimation unit.

5. The information processing device according to claim 4, further comprising
a corresponding point detection unit that detects corresponding points in a plurality of the captured images, wherein
the posture estimation unit estimates a posture of the camera by using the corresponding points detected by the corresponding point detection unit.

6. The information processing device according to claim 5, wherein
the corresponding point detection unit detects the corresponding points in the plurality of captured images obtained by capturing projection images of respective colors from different positions.

7. The information processing device according to claim 6, wherein
the corresponding point detection unit separates the projection images in the captured images of projection images of different colors projected simultaneously from a plurality of projection units, and derives captured images of projection images of different colors.

8. The information processing device according to claim 7, wherein
the corresponding point detection unit derives captured images of the projection images of the respective colors for the respective projection units by separating the projection images in the plurality of captured images of the projection images of different combinations of colors.

9. The information processing device according to claim 1, wherein
the color shift correction unit performs geometric correction to correct the color shift.

10. The information processing device according to claim 5, wherein
the corresponding point detection unit detects the corresponding points in the plurality of captured images obtained by capturing a same projection image from different positions for each color.

11. The information processing device according to claim 10, wherein
the color shift correction unit corrects the color shift to be sufficiently small.

12. The information processing device according to claim 10, wherein
the color shift correction unit performs correction in such a manner that a color shift from a predetermined target color becomes sufficiently small.

13. The information processing device according to claim 12, wherein
the target color is white.

14. The information processing device according to claim 10, wherein
the corresponding point detection unit separates the projection images in the captured images of projection images of different colors projected simultaneously from a plurality of projection units, derives captured images of projection images of different colors, and detects the corresponding points for each color.

15. The information processing device according to claim 14, wherein
the color shift correction unit performs geometric correction in such a manner that the color shift amount derived by the color shift amount derivation unit is reduced.

16. The information processing device according to claim 1, further comprising
a projection control unit that projects a corrected image reflecting the correction of the color shift by the color shift correction unit.

17. The information processing device according to claim 16, wherein
the projection control unit further projects a grid image.

18. The information processing device according to claim 1, further comprising
an imaging unit that captures a projection image projected by the projection unit and generates a captured image of the projection image.

19. The information processing device according to claim 1, further comprising
the projection unit.

20. An information processing method comprising
correcting a color shift on a basis of a three-dimensional (3D) projection position of each of optical devices of a projection unit that projects red, green, and blue (RGB) light using the optical devices different from each other.
